(19) United States
(12) Patent Application Publication
(10) Pub. No.: US 2026/0368258 A1
(43) Pub. Date: Nov. 19, 2026

(54) METHODS AND SYSTEMS FOR CONTENT FILTERING

(71) Applicant: Comcast Cable Communications, LLC, Philadelphia, PA (US)

(72) Inventors: Kishorekumar SundaraRajan, Washington, DC (US); Adeep Hande, Washington, DC (US)

(21) Appl. No.: 19/211,817

(22) Filed: May 19, 2025

(51) Int. Cl. G06F 16/9035

(52) U.S. Cl. CPC G06F 16/9035

(57) ABSTRACT

Methods, apparatuses, and systems are described for detecting anomalies associated with search results and filtering content based on the detected anomalies. A search query may be received that comprises one or more search terms. One or more search results comprising content associated with one or more filter terms that are related to the one or more search terms be determined. A weight may be assigned to each of the filter terms based on whether each of the filter terms comprises an anomalous term that is related to inappropriate content. The weight may be adjusted lower, making the filter term less negative, if it matches at least one of the search terms. The higher the weight associated with a filter term the more likely the filter term comprises an anomalous term associated with inappropriate content that should be removed from the search results before the search results are output.

### BACKGROUND

Users often rely on search functionality to find relevant content efficiently on television and entertainment platforms. Current search and filtering systems often employ Automatic Speech Recognition (ASR) and Natural Language Processing (NLP) technologies to process voice and text queries. However, these systems face significant challenges in accurately detecting and responding to contextually inappropriate content in real-time. These systems must process and analyze vast amounts of data quickly to provide timely search results as the volume of online content continues to grow exponentially, resulting in trade-offs between accuracy and speed, potentially compromising the quality of content moderation. Moreover, these systems struggle to reliably identify and remove inappropriate content while preserving relevant search results, especially when dealing with complex queries or evolving language usage. They often rely on static or fixed keyword lists, or simplistic matching algorithms, which can lead to both false positives and false negatives and to incorrectly flagging benign content as inappropriate or failing to catch subtle instances of objectionable material. New terms, slang, and euphemisms emerge rapidly, making it difficult for static/fixed filtering systems to keep pace with evolving forms of inappropriate content. These systems lack the ability to adapt to changing linguistic contexts or user-specific preferences, resulting in a one-size-fits-all approach that may not adequately serve diverse user needs. As a result, these systems often either over-filter, blocking broad categories of content and potentially limiting user access to desired material, or under-filter, allowing inappropriate and unwanted material to appear in search outputs. Addressing these technical challenges in search result filtering and content moderation is crucial for improving the overall quality and safety of online search experiences. The disclosure described herein aims to tackle these issues by introducing novel approaches to anomaly detection and contextual analysis in search results.

### SUMMARY

It is to be understood that both the following general description and the following detailed description are exemplary and explanatory only and are not restrictive. Methods, systems, and apparatuses for detecting anomalies associated with search results and filtering content based on the detected anomalies are described.

The present disclosure relates to methods and systems for detecting and filtering contextually inappropriate content from search results. A computing device may analyze search queries and associated results to identify potentially anomalous or inappropriate content based on weighted filter terms. The system may adjust term weights by considering whether terms appear in the original search query, allowing for more nuanced filtering. Machine learning models may be applied to further refine the detection and filtering process, improving accuracy in identifying truly inappropriate content while preserving relevant results. This summary is not intended to identify critical or essential features of the disclosure, but merely to summarize certain features and variations thereof. Other details and features will be described in the sections that follow.

### BRIEF DESCRIPTION OF THE DRAWINGS

The accompanying drawings, which are incorporated in and constitute a part of the present description serve to explain the principles of the apparatuses and systems described herein:

FIG. 1 shows an example system environment;

FIG. 2 shows an example process;

FIG. 3 shows an example relevance scoring system;

FIGS. 4A-4B show an example validation process;

FIG. 5 shows an example relevancy and validation process;

FIG. 6 shows an example machine learning system;

FIG. 7 shows a flowchart of an example machine learning method;

FIG. 8 shows a flowchart of an example method;

FIG. 9 shows a flowchart of an example method;

FIG. 10 shows a flowchart of an example method; and

FIG. 11 shows a block diagram of an example system and computing device.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. When values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude other components, integers or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, magnetic storage devices, memresistors, Non-Volatile Random Access Memory (NVRAM), flash memory, or a combination thereof.

Throughout this application reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Accordingly, blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

This detailed description may refer to a given entity performing some action. It should be understood that this language may in some cases mean that a system (e.g., a computer) owned and/or controlled by the given entity is actually performing the action.

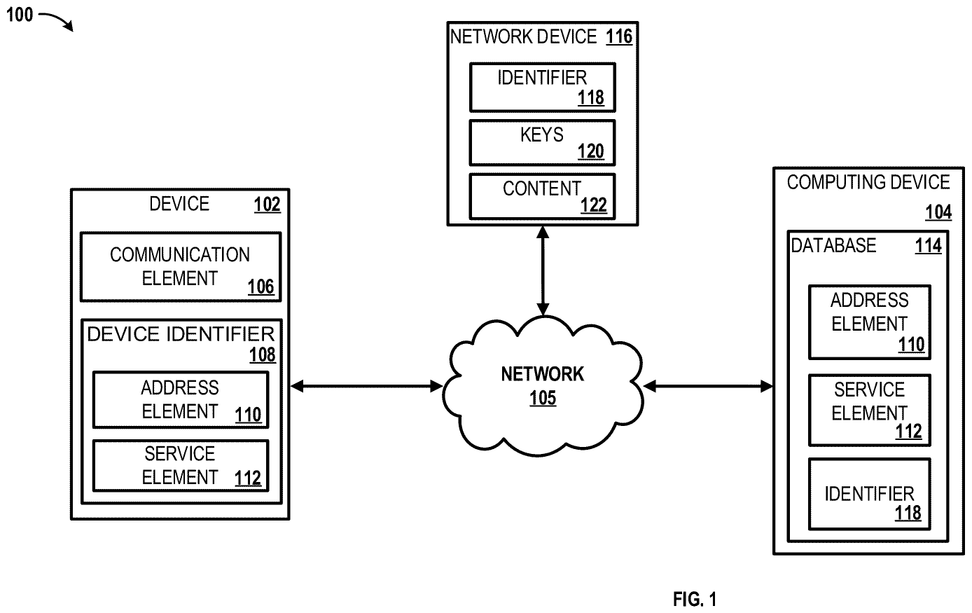

FIG. 1 shows an example system 100 for detecting anomalies, or contextually inappropriate content, associated with search results and filtering the search results based on the detected anomalies. For example, a user may provide, or input, a search query, via a computing device, that comprises one or more search terms. The computing device may filter the search results before outputting the search results to a user. The system 100 may be configured to provide services, such as network-related services, to a device (e.g., device 102). The network and system may comprise a device 102 in communication with a computing device 104, such as a server, via a network 105. The computing device 104 may be disposed locally or remotely relative to the device 102. As an example, the device 102 and the computing device 104 can be in communication via a private and/or public network 105 such as the Internet or a local area network (LAN). Other forms of communications can be used such as wired and wireless telecommunication channels, for example. The device 102 may comprise an electronic device such as a smart television, a computer, a smartphone, a laptop, a tablet, a set top box, a display device, or other device capable of communicating with the computing device 104.

The device 102 may comprise a communication element 106 for providing an interface to a user to interact with the device 102 and/or the computing device 104. The communication element 106 can be any interface for presenting and/or receiving information to/from the user, such as user feedback. An example interface may be a communication interface such as a web browser (e.g., Internet Explorer®, Mozilla Firefox®, Google Chrome®, Safari®, or the like). Other software, hardware, and/or interfaces can be used to provide communication between the user and one or more of the device 102 and the computing device 104. As an example, the communication element 106 can request or query various files from a local source and/or a remote source. As an example, the communication element 106 can transmit data to a local or remote device such as the computing device 104.

The device 102 may be associated with a user identifier or a device identifier 108. As an example, the device identifier 108 may be any identifier, token, character, string, or the like, for differentiating one user or user device (e.g., device 102) from another user or user device. In an example, the device identifier 108 may identify a user or user device as belonging to a particular class of users or user devices. As an example, the device identifier 108 may comprise information relating to the device 102 such as a manufacturer, a model or type of device, a service provider associated with the device 102, a state of the device 102, a locator, and/or a label or classifier. Other information can be represented by the device identifier 108.

The device identifier 108 may comprise an address element 110 and a service element 112. In an example, the address element 110 can comprise or provide an internet protocol address, a network address, a media access control (MAC) address, international mobile equipment identity (IMEI) number, international portable equipment identity (IPEI) number, an Internet address, or the like. As an example, the address element 110 can be relied upon to establish a communication session between the device 102 and the computing device 104 or other devices and/or networks. As an example, the address element 110 can be used as an identifier or locator of the device 102. In an example, the address element 110 can be persistent for a particular network.

The service element 112 may comprise an identification of a service provider associated with the device 102, with the class of device 102, and/or with a particular network 105 with which the device 102 is currently accessing services associated with the service provider. The class of the device 102 may be related to a type of device, capability of device, type of service being provided, and/or a level of service (e.g., business class, service tier, service package, etc.). As an example, the service element 112 may comprise information relating to or provided by a communication service provider (e.g., Internet service provider) that is providing or enabling data flow such as communication services to the device 102. As an example, the service element 112 may comprise information relating to a preferred service provider for one or more particular services relating to the device 102. In an example, the address element 110 can be used to identify or retrieve data from the service element 112, or vice versa. As an example, one or more of the address element 110 and the service element 112 may be stored remotely from the device 102 and retrieved by one or more devices such as the device 102 and the computing device 104. Other information may be represented by the service element 112.

A network device 116 may be in communication with a network, such as the network 105. For example, the network device 116 may facilitate the connection of a device (e.g., device 102) to the network 105. As an example, the network device 116 may be configured as a set-top box, a gateway device, or wireless access point (WAP). In an example, the network device 116 may be configured to allow one or more wireless devices to connect to a wired and/or wireless network using Wi-Fi, Bluetooth®, Zigbee®, or any desired method or standard.

The network device 116 may comprise an identifier 118. As an example, the identifier 118 may be or relate to an Internet Protocol (IP) Address (e.g., IPV4/IPV6) or a media access control address (MAC address) or the like. As an example, the identifier 118 may be a unique identifier for facilitating communications on the physical network segment. In an example, the network device 116 may comprise a distinct identifier 118. As an example, the identifier 118 may be associated with a physical location of the network device 116.

The computing device 104 may comprise a server for communicating with the device 102 and/or a network device 116. As an example, the computing device 104 may communicate with the device 102 for providing data and/or services. As an example, the computing device 104 may provide services, such as network (e.g., Internet) connectivity, network printing, media management (e.g., media server), content services, streaming services, broadband services, or other network-related services. As an example, the computing device 104 may allow the device 102 to interact with remote resources, such as data, devices, and files. As an example, the computing device 104 may be configured as (or disposed at) a central location (e.g., a headend, or processing facility), which may receive content (e.g., data, input programming) from multiple sources. The computing device 104 may combine the content from the multiple sources and may distribute the content to user (e.g., subscriber) locations via a distribution system.

The computing device 104 may be configured to manage the communication between the device 102 and a database 114 for sending and receiving data therebetween. As an example, the database 114 may store a plurality of files (e.g., web pages), user identifiers or records, or other information. As an example, the device 102 may request and/or retrieve a file from the database 114. In an example, the database 114 may store information relating to the device 102 such as the address element 110, and/or the service element 112. As an example, the computing device 104 may obtain the device identifier 108 from the device 102 and retrieve information from the database 114 such as the address element 110, the service element 112. As an example, the computing device 104 may obtain the address element 110 from the device 102 and may retrieve the service element 112 from the database 114, or vice versa. Any information may be stored in and retrieved from the database 114. The database 114 may be disposed remotely from the computing device 104 and accessed via direct or indirect connection. The database 114 may be integrated with the computing device 104 or some other device or system.

A computing device (e.g., device 102, network device 116, computing device 104, etc.) may be configured to output search results based on a search query received by a user. The search query may comprise one or more search terms. As an example, the search query may comprise one or more of voice input, image input, or text input comprising the one or more search terms. The computing device may determine one or more search results based on the one or more search terms. For example, the one or more search results may comprise content associated with one or more filter terms that are related to the one or more search terms. The content associated with the one or more filter terms may comprise one or more of video content associated with the one or more filter terms, audio content associated with the one or more filter terms, or text content associated with the one or more search terms. As an example, one or more video content items may be output to a user that are associated with the one or more filter terms. As an example, one or more audio content items may be output to a user that are associated with the one or more filter terms. As an example, one or more text descriptions associated with one or more content items may be output to a user that are associated with the one or more filter terms. A weight may be assigned to each filter term of the one or more filter terms based on each of the filter terms' relatedness to inappropriate content (e.g., adult content/language, offensive content/language, etc.). For example, a higher weight/value may be assigned to a filter term (e.g., a negative term) the more likely it is related to inappropriate content. For example, a weight/value that satisfies a threshold (e.g., is above the threshold) may indicate that a filter term is associated with inappropriate content. For example, the higher weight that satisfies the threshold (e.g., is above the threshold) may indicate that the filter term comprises an anomalous term, and thus, is associated with inappropriate content. As an example, the weights may be assigned to the filter terms based on one or more criteria such as text-analysis, phrase-level embeddings, word-level embeddings, character level embeddings, sub-word tokenization, sentence embeddings, named entity recognition (NER), parts of speech tagging (POS Tagging), semantic similarity scoring, contextual embeddings, and transformer-based sequence modeling, etc. As an example, the computing device may filter (e.g., rank) the one or more search results based on each weight assigned to each filter term. For example, content associated with filter terms associated with higher weights, indicating a higher likelihood the filter term comprises an anomalous term associated with inappropriate content, may be ranked lower amongst the search results. As result, content associated with an anomalous term is less likely to be included in the search results output (e.g., displayed) to a user. As an example, the computing device may remove search results associated with filter terms with weights that satisfy the threshold (e.g., above the threshold) from the one or more search results. For example, if the filter term is associated with a weight that satisfies the threshold (e.g., is above the threshold), and thus, comprises an anomalous term that is associated with inappropriate content, the computing device may remove the inappropriate content associated with the filter term from the one or more search results prior to outputting the one or more search results to a user.

As an example, the computing device may also determine whether the filter term matches at least one search term of the one or more search terms. If the filter term matches the at least one search term, the computing device may adjust the weight associated with the filter term. For example, the weight may be adjusted lower based on the filter term matching the at least one search term. For example, the weight associated with the filter term may be adjusted such that the filter term becomes less negative if it is used in the search query. As an example, the computing device may filter (e.g., rank) the one or more search results based on each adjusted weight of each filter term. As an example, if the adjusted weight associated with the filter term satisfies the threshold (e.g., remains above the threshold), the computing device may remove the content associated with the filter term from the one or more search results prior to outputting the one or more search results to a user. If the adjusted weight associated with the filter term does not satisfy the threshold (e.g., is below the threshold), the content associated with the filter term may be kept in the one or more search results. In an example, a weight/value (e.g., an impact relevancy score) may be assigned to the search query (e.g., based on the weights, or adjusted weights, of the one or more filter terms associated with the search query). The computing device may compare the adjusted weight, associated with the filter term, with the search query weight (e.g., impact relevancy score) to determine whether to remove the content associated with the filter term from the one or more search results. For example, if a search query's weight does not satisfy the threshold (e.g., falls below the threshold) while the filter term satisfies the threshold (e.g., exceeds the threshold), the computing device may remove the content associated with the filter term from the one or more search results. Thus, the weights of the filter terms may be adjusted in order to accommodate for the context of the search terms of the search query in order to indicate anomalies associated with contextually inappropriate content. For example, these anomalies may be defined as search results that contain any inappropriate content relevant to the search query, when the search query did not specifically include terms directed to the inappropriate content. However, the search terms may not be considered anomalies if the search query includes terms directed towards such content. This enables the computing device to analyze the search query to identify search results that are more relevant to the search query without over-filtering the search results, blocking categories of content and potentially limiting user access to desired material. Thus, the computing device may appropriately filter the search results, without under-filtering the search results, in order to remove contextually inappropriate content from the search results.

As an example, a search query may cause the output of search results comprising content related to filter terms that include “underpants.” For example, some of the search results may include inappropriate content due to the filter term, “underpants.” The inappropriate content may be filtered out of the search results based on a weight assigned to the filter term, “underpants,” indicating that it is associated with inappropriate content. However, if the search terms, “underpants,” are included in the search query, the weight assigned to the filter terms “underpants” may be adjusted lower causing the filter terms to become less “negative.” As a result, content associated with the filter terms “underpants” may be included in the search results. In one example, a user may search for the movie titled “Captain Underpants.” As such, content associated with the movie may be output to the user. In another example, a user may use the search terms “underpants” in relation to a search for different types of undergarments. As such, content associated with different types of undergarments may be output to the user. However, for example, if all content is filtered out in relation to the search term “underpants” simply because of the identification of inappropriate content related to the search terms, a user would not be able to receive information related to the user's specific search queries related to specific topics. Thus, as a result, only contextually inappropriate content may be filtered from being output to a user based on the context of the search terms comprising the user's search query.

In an example, a machine learning model (e.g., a large language model (LLM)) may be implemented by the computing device to validate whether the filter terms are associated with inappropriate content. For example, a filter term that is determined to comprise an anomalous term that is associated with inappropriate content may be provided to the machine learning model, wherein the machine learning model may further process the filter term to confirm whether the filter term comprises an anomalous term that is associated with inappropriate content. If the machine learning model confirms that the filter term comprises an anomalous term that is associated with inappropriate content, the filter term may be provided to an anomaly database (e.g., database 114) for storage, wherein the weight associated with the filter term may be adjusted higher, providing a stronger indication that the filter term is associated with inappropriate content. If the machine learning model determines that the filter term does not comprise an anomalous term associated with inappropriate content, the weight associated with the filter term may be adjusted lower such that the filter term becomes less negative, and thus, validating that the filter term does not comprise an anomalous term, for example.

Incorporating a machine learning model, such as a large language model, into the weight adjustment process may enhance the system's ability to understand complex contextual relationships and evolving language patterns. This approach allows for more nuanced and adaptive content analysis, reducing both false positives and false negatives in identifying inappropriate content. The use of machine learning enables the system to continuously refine its understanding of what constitutes anomalous or inappropriate content, adapting to changing linguistic and cultural norms over time. Additionally, by considering both the weights of filter terms and search terms in conjunction with machine learning insights, the method provides a more comprehensive and context-aware evaluation of content appropriateness. This multi-faceted approach leads to more accurate and efficient filtering of search results, improving the overall user experience while maintaining robust content safety standards.

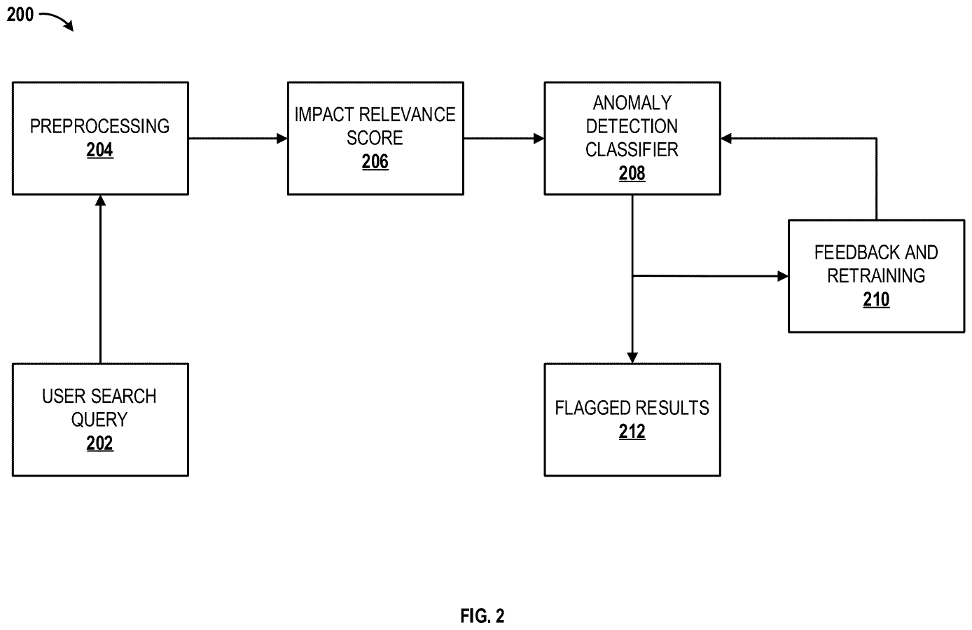

FIG. 2 shows an example process 200 for identifying filter terms that comprise anomalous terms associated with inappropriate content (e.g., anomalous content) and identifying content associated with the filter terms comprising the anomalous terms. At 202, user input comprising a search query Q may be received. The search query may comprise one or more search terms. For example, the search query may comprise one or more of voice input, image input, or text input comprising one or more search terms.

At 204, the search query may undergo preprocessing to determine the one or more search terms from the search query. For example, the search query may be preprocessed to remove white spaces, special characters, and the like. In an example, the voice input may be preprocessed (e.g., via one or more voice-to-text algorithms) to identify one or more search terms provided via the voice input. In an example, the image input may be preprocessed (e.g., via one or more content recognition algorithms) to identify one or more search terms provided via the image input. In an example, the text input may be preprocessed (e.g., via one or more optical character recognition algorithms) to identify one or more search terms provided via the text input. In addition, one or more search results may be determined based on the one or more search terms. For example, the one or more search results may comprise content associated with one or more filter terms that are related to the one or more search terms. The content associated with the one or more filter terms may comprise one or more of video content associated with the one or more filter terms, audio content associated with the one or more filter terms, or text content associated with the one or more search terms. As an example, one or more video content items may be output to a user that are associated with the one or more filter terms. As an example, one or more audio content items may be output to a user that are associated with the one or more filter terms. As an example, one or more text descriptions associated with one or more content items may be output to a user that are associated with the one or more filter terms.

At 206, an impact relevancy score (e.g., weight) may be determined for the search query based on one or more weights associated with the one or more filter terms. For example, a weight may be assigned to each filter term of the one or more filter terms based on each of the filter terms' relatedness to inappropriate content (e.g., adult content/language, offensive content language, etc.). As an example, the weights may be assigned to the filter terms based on one or more criteria such as text-analysis, phrase-level embeddings, word-level embeddings, character level embeddings, sub-word tokenization, sentence embeddings, named entity recognition (NER), parts of speech tagging (POS Tagging), semantic similarity scoring, contextual embeddings, and transformer-based sequence modeling, etc. As an example, the one or more search results may be filtered (e.g., ranked) based on the corresponding weight assigned to each filter term in order to derive the top k results from the search query.

At 208, the weighted filter terms may be provided to an anomaly detection classifier (e.g., an heuristic classifier), wherein the anomaly detection classifier may determine whether any of the filter terms comprise an anomalous term, and thus, associated with inappropriate content. For example, a higher weight/value may be assigned to a filter term (e.g., a negative term) the more likely it is related to inappropriate content. For example, a weight/value that satisfies a threshold (e.g., is above the threshold) may indicate that a filter term is associated with inappropriate content. For example, the higher weight that satisfies the threshold (e.g., is above the threshold) may indicate that the filter term comprises an anomalous term, and thus, is associated with inappropriate content. In an example, if a filter term matches at least one of the search terms, the weight of the filter term may be adjusted. For example, the weight may be adjusted higher based on the filter term matching the at least one search term. For example, the weight associated with the filter term may be adjusted such that the filter term becomes less negative if it is used in the search query.

At 210, the output of the anomaly detection classifier may be used as feedback to retrain the anomaly detection classifier, wherein the retrained anomaly detection classifier may identify filter terms comprising anomalous terms associated with inappropriate content at 208. At 212, flagged results may be output by the anomaly detection classifier. For example, the filter terms comprising anomalous terms associated with inappropriate content and search results associated with the anomalous terms may be identified. In an example, the one or more search results may be filtered (e.g., ranked) based on each adjusted weight of each filter term. As an example, if the adjusted weight associated with the filter term satisfies the threshold (e.g., remains above the threshold), the computing device may remove the content associated with the filter term from the one or more search results prior to outputting the one or more search results to a user. If the adjusted weight associated with the filter term does not satisfy the threshold (e.g., is below the threshold), the content associated with the filter term may be kept in the one or more search results.

The method 200 described in FIG. 2 provides a technical improvement to the problem of accurately filtering search results in real-time while maintaining relevance and context. By implementing a dynamic weighting system for filter terms and utilizing an anomaly detection classifier, the method enhances the accuracy and efficiency of content filtering. This approach allows for more nuanced analysis of search queries and results, reducing both false positives and false negatives in identifying inappropriate content. For example, the feedback loop at step 210 enables continuous improvement of the anomaly detection classifier, allowing the system to adapt to evolving language usage and content trends. Additionally, by considering the context of search terms within queries, the method 200 may strike a balance between removing truly inappropriate content and preserving access to relevant information. This contextual understanding may help overcome limitations of static keyword-based filtering systems, improving the overall user experience while maintaining content safety standards.

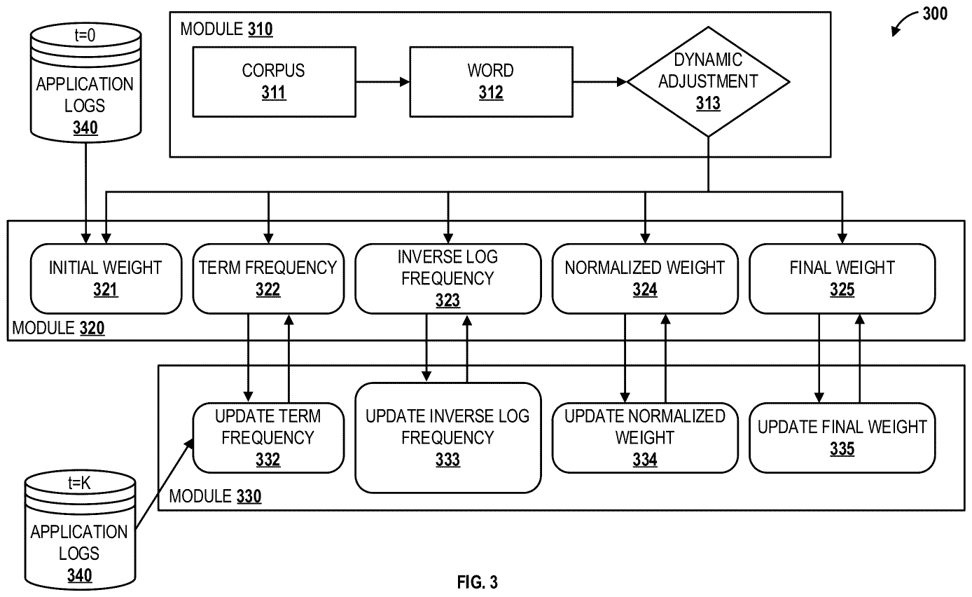

FIG. 3 shows an example impact relevance scoring system 300 for assigning and adjusting the weights associated with the filter terms. For example, the impact relevance scoring system 300 may receive a search query comprising one or more search terms. For example, the search query may comprise one or more of voice input, image input, or text input. Module 310 may analyze the search query to identify one or more filter terms related to the one or more search terms of the search query. For example, the module 310 may analyze the one or more search terms against a corpus 311 of filter terms. One or more filter words/terms 312 may be identified that are related to the one or more search terms. A weight may be assigned to each of the one or more filter terms. For example, the weight may be assigned to each filter term based on each of the filter terms' relatedness to inappropriate content (e.g., adult content/language, offensive content language, etc.). For example, a higher weight may be assigned to a filter term (e.g., a negative term) the more likely it is related to inappropriate content (e.g., anomalous content). For example, a weight that satisfies a threshold (e.g., that is above the threshold) may indicate that a filter term is associated with inappropriate content. As an example, the weights may be assigned to the filter terms based on one or more criteria such as text-analysis, phrase-level embeddings, word-level embeddings, character level embeddings, sub-word tokenization, sentence embeddings, named entity recognition (NER), parts of speech tagging (POS Tagging), semantic similarity scoring, contextual embeddings, and transformer-based sequence modeling, etc. The module 310 may perform a dynamic weight adjustment 313 to the weights assigned to each of the filter terms. For example, a weight of a filter term may be adjusted if the filter term appears in the search query (e.g., the filter term matches a search term of the search query).

As an example, the module 311 may provide the weighted filter terms to module 320 for determining an initial weight for each of the filter terms. As an example, the impact relevance scoring system 300 may utilize time as an additional signal to help better identify the relevance of the high-risk phrases, as well as dynamically adapt to any changes/meanings of words/key phrases based on a context of a search query, cultural aspects, etc. The module 321 may access application logs 340 at t=0 for determining an initial weight for each of the filter terms. For example, a term frequency 322 and an inverse log frequency 323 may be analyzed and the weights may be normalized 324 before a final weight 325 is determined for each of the filter terms. For example, the impact relevance score, IR(L) for Lexicon Lᵢ may be identified at time t=0 and may be defined as:

$${IR ( L )}_{t = 0} = 1 - \frac{{Σ}_{i ∈ k}^{k} {L}_{i}}{g ( Q )} ,$$

wherein the equation is the inverse log frequency 323 of the lexicon Lᵢ in the total command logs occurrence Q at time t=0. In addition, at a subsequent time, t=k, the updated static score may be updated and defined as IR_{updated}(L). The impact relevancy score for lexicon Lᵢ may be updated to adapt to the new degree of relevancy, incorporating an additional weighting factor. The IR score for Lexicon Lᵢ at time t=k may be defined as:

IR(Lᵢ)ₜ₌ₖ=α·IR(Lᵢ)ₜ₌₀+(1−α)·IR_{updated}(Lᵢ),

wherein a is a weighting factor that emphasizes the initial impact relevancy score at t=0 for lexicon Lᵢ.

A feedback loop may be performed between the module 320 and module 330. For example, the application logs 340 may be accessed at t=k. For example, an updated term frequency 332 and an updated inverse log frequency 333 may be analyzed, and an updated normalized weight 334 may be calculated before an updated final weight 335 may be determined. The updated term frequency 332 may be fed back into the term frequency 322, the updated inverse log frequency 333 may be fed back into the inverse log frequency 323, the updated normalized weight 334 may be fed back into the normalized weight 324, and the updated final weight 335 may be fed back into the final weight 325 to continuously update the weights associated with each of the filter terms. In example, the updated relevancy scores for Lexicons L may be normalized to avoid inverse scores too close to 1 to avoid skewing the anomaly detection classifier. In addition, log normalization is applied to the IR scores across lexicons at every step, independent of time, t. For example, the normalized IR score may be defined as:

IR_{normalized}(Lᵢ)=log (1+IR(Lᵢ))

To determine the similarity between the search query Q and Rᵢ for i∈k, wherein Rᵢ represents the search results, embeddings from a pretrained embeddings may be used, such as:

$$C ( Q , {R}_{i} ) = \frac{h ( Q ) \cdot ( h ( {R}_{i} ) )}{\vert h ( Q ) \vert \vert h ( {R}_{i} ) \vert} ,$$

wherein h(⋅) represents the embedding function which converts Q, R to its respective vector representations. Thus, the anomaly detection classifier may be triggered only if Rᵢ is not an exact match to Q, as if otherwise, specific content was requested, and it is not an anomaly. If Q≠Rᵢ, the anomaly detection classifier may be triggered to assess a contextual relevance of a search result and assign an anomaly score (e.g., weight) to the related filter term: A(Rᵢ/Q)=f(Rᵢ, Mᵢ, Q), wherein A(Ri/Q) represents the anomaly score of Search Results Rᵢ based on the search query Q, and f(Rᵢ, Mᵢ, Q) is the anomaly detection classifier function assessing the degree of anomaly, which may use metadata M (e.g., age rating, program genre, content descriptions, etc.) of the Search Result Rᵢ to further help contextualize and analyze the Search Result Rᵢ.

The overall scoring function g(x) may determine an anomaly in a input string x, wherein x∈{Q, R, M}. For example:

$$g ( x ) = \{ \frac{1}{n} {Σ}_{i = 1}^{n} {IR}_{normalized} ( {L}_{i} ) if {L}_{i} ∈ x , 0 otherwise \} ,$$

wherein n is the total number of lexicons in the input string x. Scores for Search Query Q, metadata M, and Search Result R may be represented as:

$$g ( Q ) = \frac{1}{{n}_{Q}} {Σ}_{i = 1}^{{n}_{Q}} {IR}_{normalized} ( {L}_{i} ) ,$$

$$g ( M ) = \frac{1}{{n}_{M}} {Σ}_{i = 1}^{{n}_{M}} {IR}_{normalized} ( {L}_{i} ) ,$$

$$g ( R ) = \frac{1}{{n}_{R}} {Σ}_{i = 1}^{{n}_{R}} {IR}_{normalized} ( {L}_{i} ) ,$$

wherein n_{Q}, n_{R}, n_{M} are counts of lexicons in the Search Query Q, metadata M, and Search Result R.

In an example, anomalies may be identified based on a user defined threshold B, which may be defined as 25^{th} percentile IR scores:

β=Percentile(IR₍ₜ₎,25)=IR(0.25·N)

The anomaly detection classifier classifies a Search Result Rᵢ as anomalous if g(Q)<β and (g(Rᵢ)>β or g(Mᵢ)>β). Each string, including Q, Rᵢ, and Mᵢ may be encoded into vector representations using pretrained embeddings. Thus, anomalous content (e.g., contextually inappropriate content) may be distinguished from non-anomalous content by utilizing a lexicon-based scoring method, wherein the anomalous scores (e.g., weights) may be updated over time depending on a severity of the words/phrases/terms (e.g., of the filter terms) in an ever-evolving cultural context.

The impact relevance scoring system 300 described in FIG. 3 provides a technical solution to the challenge of dynamically and accurately filtering search results in real-time. By implementing a multi-faceted approach that combines initial weighting, time-based adjustments, and feedback loops, the system 300 adapts to evolving language usage and cultural contexts. The use of lexicon-based scoring, along with the incorporation of metadata and vector representations, enables more nuanced content analysis beyond simple keyword matching. This approach improves the accuracy of anomaly detection by considering the contextual relevance of search results and queries. The system's 300 ability to normalize scores and apply log transformations prevents skewing in the anomaly detection process, reducing false positives and negatives. Additionally, the continuous updating of weights through feedback loops allows the system 300 to learn and improve over time, addressing the technical problem of maintaining relevance in rapidly changing linguistic environments. This adaptive capability enhances both the efficiency and effectiveness of content filtering, leading to improved user experiences and more robust content moderation systems.

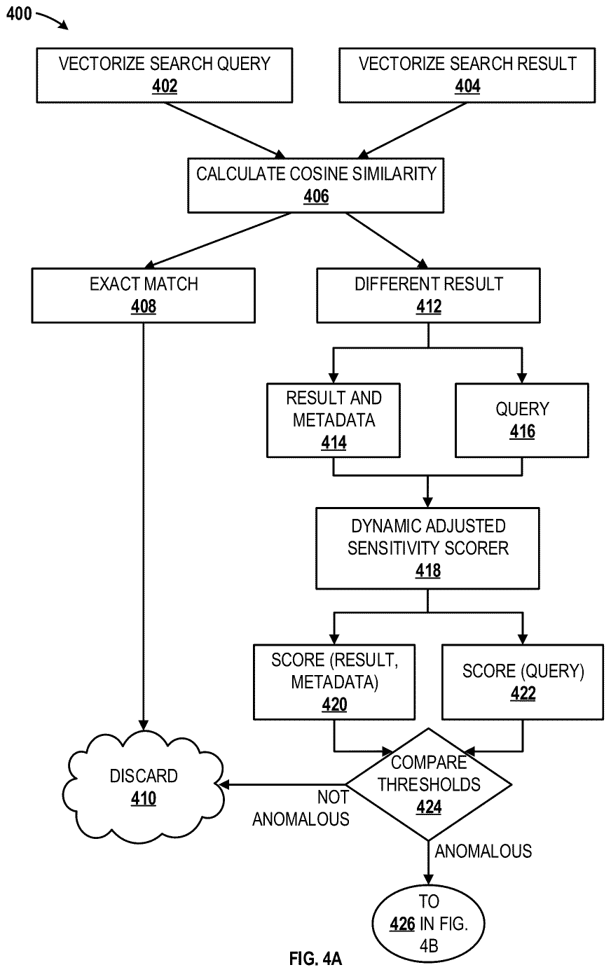

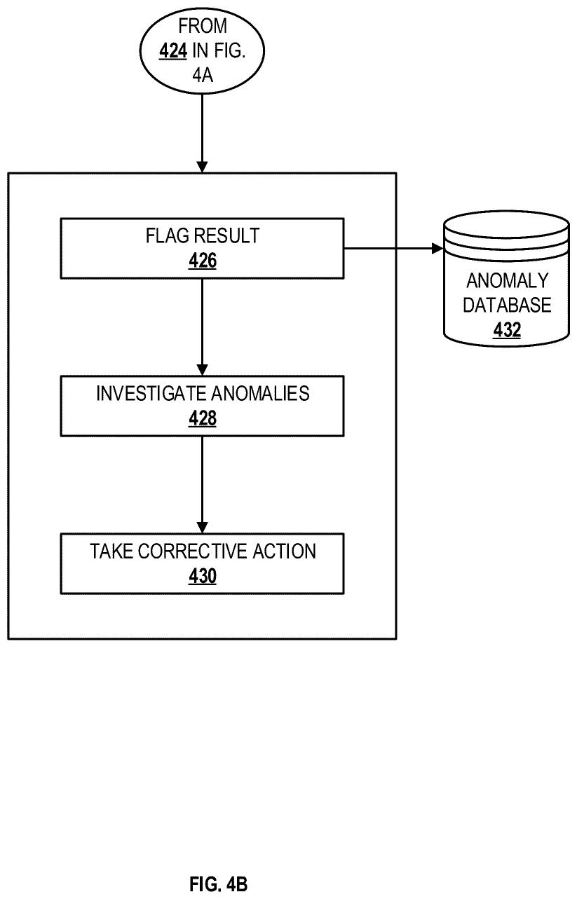

FIGS. 4A-4B shows an example validation process 400 for validating inappropriate terms. As an example, a machine learning model such as a large language model (LLM) may be utilized as a validation tool for analyzing content anomalies within a search query and search result pair. One or more search queries 402 and one or more search results 404 may be received and vectorized. A cosine similarity 406 may be calculated based on the vectorized search queries 402 and the vectorized search results 404 in order to determine anomalous and non-anomalous terms (e.g., filter terms comprising anomalous terms associated with contextually inappropriate content and filter terms that do not comprise anomalous terms). For example, by computing the cosine similarity 406, exact or redundant matches may be filtered out in order to provide a heavier focus on search results where there might be a misalignment. If the output of the cosine similarity 406 calculation indicates an exact match 408 between a vectorized search query 402 and a vectorized search result 404 indicating a non-anomalous search result, the search result may be discarded 410. However, if the output of the cosine similarity 406 calculation indicates that a vectorized search query 402 does not match 412 a vectorized search result 404, indicating an anomalous search result, the search result may be further analyzed, wherein the search result and associated metadata 414 and the search query 416 may be provided to a dynamic adjusted sensitivity scorer 418. The dynamic adjusted sensitivity scorer 418 may determine a final score/weight 420 for each of the one or more search results 414 and a final score/weight 422 for each of the one or more search queries 422.

Based on comparing 424 the final weight 420 of the search result and associated metadata 414 with the final weight 422 of the search query 416, it may be determined that the search result and associated metadata 414 is associated with a non-anomalous word/term, and thus, may be discarded 410. However, the search result 414 may be determined to be associated with an anomalous word/term based on comparing 424 the final weight 420 of the search result and metadata 414 with the final weight 422 of the search query 416, and thus, may be flagged 426.

As an example, the comparison 424 may be based on an implementation of an LLM. For example, the LLM may evaluate the search queries 422 and search results and metadata 420 towards primary (e.g., anomaly detection) and auxiliary tasks in order to evaluate diverse dimensions of content anomalies, using both anomaly detection (e.g., primary task) and other additional validation checks (e.g., auxiliary tasks). For example, each task Ti computed by the LLM may contribute to an aggregated validation score:

$$ValScore ( Q , {R}_{i} ) = {w}_{primary} \cdot {LLM}_{anomaly} ( Q , {R}_{i} ) + {Σ}_{i = 1}^{p} {w}_{i} \cdot {LLM}_{auxilary} ( Q , {R}_{i} ) ,$$

wherein w_{primary} and wᵢ are weights/coefficients for the primary and auxiliary tasks, respectively. In another example, the aggregated validation score may be computed based on the metadata 420 in addition to the search queries 422 and search results 420:

$$V ( Q , {R}_{i} ) = {Σ}_{i = 1}^{p} {w}_{p} \cdot {LLM}_{p} ( Q , {R}_{i} , {M}_{i} ) .$$

As an example, if ValScore (Q, Ri)>0.5, the associated term may be considered as anomalous. However, if ValScore (Q, Ri)≤0.5, the associated term may be considered as non-anomalous. In an example, LLM_{<task>} may comprise a confidence score of respective tasks. In addition, chain-of-though (CoT) prompting may be utilized to improve the decision-making process of the LLM. For example, CoT prompting structures the LLM's validation as a series of logical reasoning steps, wherein each step refines/improves the LLM's understanding of the search query-search result pair:

$${LLM}_{CoT} ( Q , {R}_{i} ) = \frac{1}{m} {Σ}_{k = 1}^{m} {Step}_{k} ( Q , {R}_{i} ) ,$$

wherein each Stepₖ represents a reasoning that assists the LLM in sequentially or understanding the anomaly validation in tandem. The LLM's final reasoning result may be a combination of CoT prompting integrated into the tasks.

As an example, the LLM validation score may be incorporated as additional negative feedback to update the scores based on non-anomalous search query-search result pairs. For example, a cumulative adjustment may be incorporated to track anomalies throughout one or more datasets/logs. At time, t=k, impact relevance (IR) scores may be computed as:

S(Lᵢ)ₜ₌ₖ=α·S(Lᵢ)ₜ₌₀+(1−α)·S_{updated}(Lᵢ).

For example, for each search query-search result pair that is identified as non-anomalous but was identified as anomalous, the IR score of each lexicon Lᵢ is updated in a batch processing style. For example, for each batch of processed results, a cumulative frequency of each lexicon Fₙₒₙ₋ₐₙₒₘₐₗₒᵤₛ for a result having the lexicons but validated as non-anomalous may be calculated, such as:

$${S ( {L}_{i} )}_{t = k} = α \cdot {S ( {L}_{i} )}_{t = 0} + ( 1 - α ) \cdot {S}_{updated} ( {L}_{i} ) \cdot ( 1 - \frac{1}{{N}_{i}} {Σ}_{j = 1}^{{N}_{i}} ValScore ( {Q}_{j} , {R}_{j} ) ) \cdot {f}_{n o r m} ( {L}_{i} ) ,$$

wherein Nᵢ is the number of non-anomalous results containing the lexicon Lᵢ and ValScore (Qⱼ, Rⱼ) is the LLM validation score for each search result pair containing lexicon Lᵢ and validated as non-anomalous.

The normalized frequency used to scale the frequency of the lexicons in the batches may be defined as:

$${f}_{n o r m} ( {L}_{i} ) = \frac{{f}_{n o n - anomalous} ( {L}_{i} )}{max ( {f}_{non - anomalous} ( L ) )} .$$

A batch average negative feedback multiplier (BAANF-scorer) that may be provided to scale down the IR score for each lexicon with respect to the LLM's confidence in its benign nature may be defined as:

$$1 - \frac{1}{{N}_{i}} {Σ}_{j = 1}^{{N}_{i}} ValScore ( {Q}_{j} , {R}_{j} ) .$$

In an example, the flagged search result 416 may be provided to an anomaly database 432 for storage. The flagged search results 426 may also be further processed and investigated 428, wherein corrective actions 430 may be taken based on the further processing and investigation 428 of the flagged search results 426. For example, the flagged search results 426 may be removed from the search results of the corresponding search query. For example, the anomaly detection classifier may be fine-tuned to process the flagged search results 426 (e.g., anomalies). Thus, it is ensured that lexicons frequently appearing in non-anomalous context are penalized. As such, the lexicons that frequently appear in non-anomalous context receive a greater decrease in scrutiny level, where lexicons with few non-anomalous validations may be affected to a lesser extent.

After each batch is processed, new scores may be computed for lexicons which may be utilized in the anomaly detection classifier. As such, the LLM feedback may be used to refine the anomality assessment across the logs periodically. This scalable feedback process has refined control over the content appropriateness tuning, allowing dynamic adjustment of lexicon scores while keeping any skewness in check. For example, the LLM may be utilized to implement multi-task validation and IR scoring for search query-search result pairs. The LLM validation process may comprise one or more processes of anomaly detection and BAANF scoring, utilizing CoT reasoning to provide comprehensive content anomalies. As an example, Table I shows example results of anomalous and non-anomalous search results-search query pairs.

| Search | | | |
|---|---|---|---|
| Command | Search Result | Label | Reason |
| Church Songs | Documentary | Y | Mismatch with user intent; |
| | on church | | highlights controversies of |
| | scandals | | requested content |
| Woman | Movies | Y | Contradicts the theme of the |
| empowerment | depicting toxic | | user query; reinforces |
| | female stereo | | negative stereotypes |
| | types or sexual | | |
| | orientation | | |
| Children's | TV series | Y | Inappropriate for the |
| shows | with adult | | intended audience; including |
| | themes | | content unsuitable for |
| | | | children |
| Educational | Science | N | Aligns with the user intent; |
| shows | documentaries | | provides age-appropriate |
| | for students | | and relevant educational |
| | | | content |

The validation process 400 described in FIGS. 4A and 4B represents a technical improvement to the problem of accurately identifying and filtering contextually inappropriate content in search results. By implementing a multi-stage approach that combines one or more of vectorization, cosine similarity calculations, and/or dynamic sensitivity scoring, the system achieves more nuanced and accurate content analysis. The use of large language models (LLMs) for validation enables the system to consider complex contextual relationships and evolving language patterns that simpler keyword-based systems might miss. The incorporation of chain-of-thought prompting may further enhance the LLM's decision-making capabilities, leading to more accurate and explainable results. Additionally, the feedback loop implemented through the batch average negative feedback (BAANF) scoring mechanism allows the system to continuously refine its understanding of what constitutes anomalous content, adapting to changing linguistic and cultural norms over time. This adaptive approach addresses the technical challenge of maintaining accurate content filtering in a rapidly evolving digital landscape, reducing both false positives and false negatives in anomaly detection while improving overall system efficiency and effectiveness.

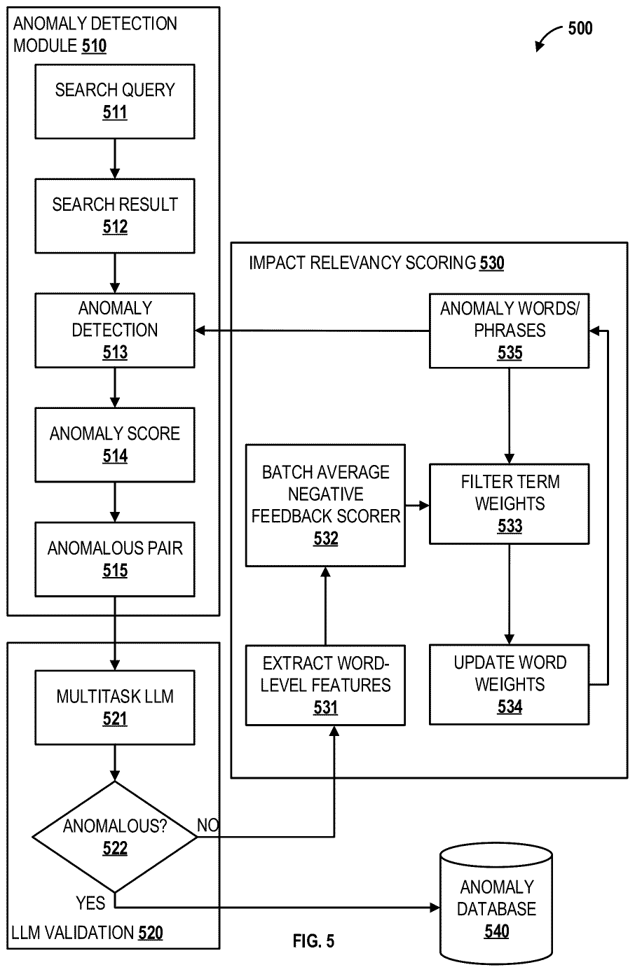

FIG. 5 shows an example relevancy and validation system 500 for validating whether a filter term comprises an anomalous term that is associated with anomalous content (e.g., contextually inappropriate content). The system 500 may include an anomaly detection module 510, a large language model (LLM) module 520, an impact relevancy scoring module 530, and an anomaly database 540. A search query 511 may be received that may comprise one or more search terms. For example, the search query 511 may comprise one or more of voice input, image input, or text input. One or more search results may be determined based on the one or more search terms. For example, the one or more search results may comprise content associated with one or more filter terms that are related to one or more search terms. The content associated with the one or more filter terms may comprise one or more of video content associated with the one or more filter terms, audio content associated with the one or more filter terms, or text content associated with the one or more search terms. As an example, one or more video content items may be output to a user that are associated with the one or more filter terms. As an example, one or more audio content items may be output to a user that are associated with the one or more filter terms. As an example, one or more text descriptions associated with one or more content items may be output to a user that are associated with the one or more filter terms.

One or more search query-search results pairs (e.g., pairs of the search queries 511 and the corresponding search results 512) may be provided to an anomaly detection classifier 514, which may assign an anomaly score (e.g., weight) to each of the one or more filter terms. For example, the weight may be assigned to each filter term of the one or more filter terms based on each of the filter terms' relatedness to inappropriate content (e.g., adult content/language, offensive content language, etc.). As an example, the weights may be assigned to the filter terms based on one or more criteria such as text-analysis, phrase-level embeddings, word-level embeddings, character level embeddings, sub-word tokenization, sentence embeddings, named entity recognition (NER), parts of speech tagging (POS Tagging), semantic similarity scoring, contextual embeddings, and transformer-based sequence modeling, etc. For example, a higher weight may be assigned to a filter term (e.g., a negative term) the more likely it is related to inappropriate content. For example, a weight that satisfies a threshold (e.g., that is above the threshold) may indicate that a filter term comprises an anomalous term that is associated with inappropriate content. In addition, the weight may be adjusted based on whether the filter term was included in the one or more search terms. For example, if the filter term matches at least one of the search terms, the weight associated with the filter term may be adjusted. For example, the weight may be adjusted lower based on the filter term matching the at least one search term. For example, the weight associated with the filter term may be adjusted such that the filter term becomes less negative if it is used in the search query.

An anomalous search term-search result pair 515 may be determined based on whether the adjusted weight associated with the filter term satisfies the threshold (e.g., is above the threshold). For example, a search term-search result pair 515 may be determined to be associated with inappropriate content if the weight associated with the filter term associated with the search result satisfies the threshold (e.g., is above the threshold). As such, the search term-search result pair 515 may be determined to be an anomalous search term-search result pair 515 based on the weight associated with the filter term satisfying the threshold (e.g., being above the threshold). The anomalous search term-search result pair 515 may be provided to the LLM module 520, wherein a multi-task LLM 521 may confirm, at 522, that the anomalous search term-search result pair 515 includes anomalous (e.g., inappropriate) words/terms. If the anomalous search term-search result pair 515 is confirmed to include anomalous words/terms, then the anomalous search term-search result pair 515 may be provided to an anomaly database 540 for storage.

If the search term-search result pair 515 is determined to not include anomalous words/terms, then the search term-search result pair 515 is provided to the impact relevancy scoring module 530. The impact relevancy scoring module 530 may extract word-level features 531 from the search term-search result pair 515. A batch average negative feedback scorer 532 may process the extracted word-level features 531 in order to generate filter term weights 533, as discussed above. The filter term weights 533 may be updated 534 if the filter term matches at least one of the search terms of the search query 511. The filter term may be determined to comprise an anomalous term that is associated with inappropriate content based on the updated weight 534. For example, if the updated weight 534 satisfies the threshold (e.g., is above the threshold), the associated filter term may be determined to comprise an anomalous term that is associated with inappropriate content. The anomalous terms 535 and updated weights 534 may be further analyzed in order to update the filter term weights 533.

The relevancy and validation system 500 described in FIG. 5 represents a technical improvement to the problem of accurately and dynamically filtering search results for inappropriate content. By implementing a multi-module approach that combines one or more of anomaly detection, large language model validation, and/or impact relevancy scoring, the system achieves more nuanced and context-aware content analysis. The use of an anomaly detection classifier 514 to initially assign weights to filter terms, followed by LLM-based validation 520, enables the relevancy and validation system 500 to consider complex contextual relationships and evolving language patterns that simpler keyword-based systems might miss. Additionally, the feedback loop implemented through the impact relevancy scoring module 530 allows the relevancy and validation system 500 to continuously refine its understanding of what constitutes anomalous content, adapting to changing linguistic and cultural norms over time. This adaptive approach addresses the technical challenge of maintaining accurate content filtering in a rapidly evolving digital landscape, reducing both false positives and false negatives in anomaly detection while improving overall system efficiency and effectiveness. The relevancy and validation system's 500 ability to extract word-level features and dynamically adjust term weights based on search query context further enhances its ability to provide relevant and appropriate search results.

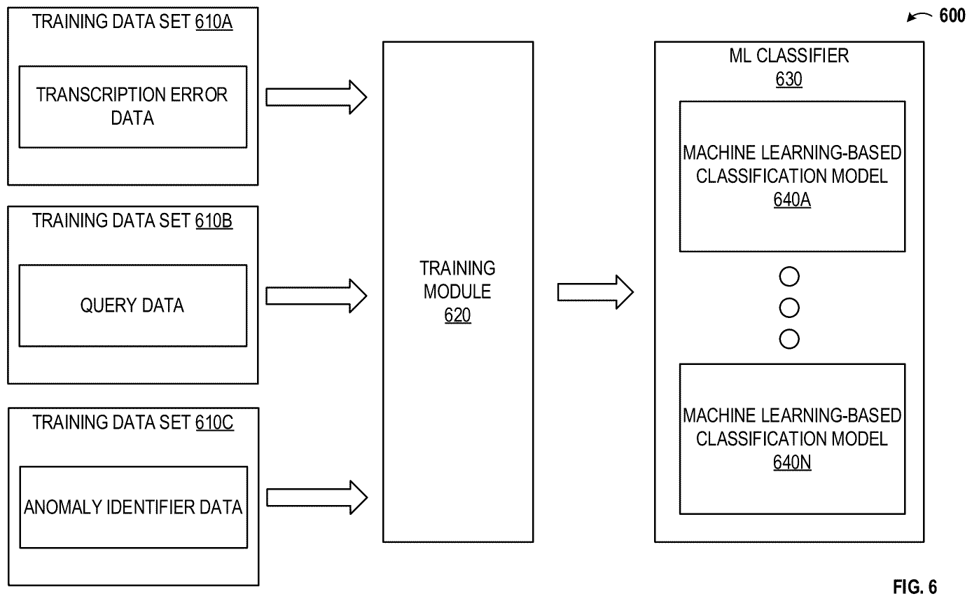

FIG. 6 shows a system 600 that may be configured to use machine learning techniques to train, based on an analysis of one or more training data sets 610A, 610B, 610C by a training module 620, at least one machine learning-based classifier 630 that is configured to output an indication a search query-search result pair (e.g., a filter term related to a search query) is associated with inappropriate content (e.g., anomalous words/terms). As an example, the training data set 610A, the training data set 610B, and the training data set 610C may each comprise one or more data sets and/or baseline feature levels. As an example, each of the training data sets 610A, 610B, 610C may comprise labeled baseline feature levels (e.g., baseline feature scores). The labels may comprise a plurality of predefined features associated with one or more characteristics associated with the transcription error data, the query data, and/or the anomaly identifier data. In an example, the training data set 610A (e.g., transcription error data), the training data set 610B (e.g., query data), and the training data set 610C (e.g., anomaly identifier data) may each be utilized to train an individual machine learning classifier/model (e.g., individual large language models (LLMs)). For example, the training data set 610A may train a first machine learning model on a first task, the training data set 610B may train a second machine learning model on a second task, and the training data set 610C may train a third machine learning model on a third task. Each of the first machine learning model, the second machine learning model, and the third machine learning model may then be combined in order to train a multi-task machine learning model (e.g., LLM). Once trained the multi-task machine learning model 630 may be configured to output an indication a search query-search result pair is associated with inappropriate content.

The training module 620 may initially train the individual machine learning classifiers/models by extracting features from the transcription error data in the training data set 610A, the query data in the training data set 610B, and the anomaly identifier data in the training data set 610C (e.g., one or more training data sets and/or baseline feature levels), respectively, according to one or more feature selection techniques. The trained individual machine learning classifiers/models may then be combined to train the multi-task machine learning-based classifier 630 by extracting a feature set from combined data of the transcription error data, the query data, and the anomaly identifier data according to one or more feature selection techniques.

In an example, the training module 620 may extract a feature set from each of the training data sets 610A-610C in a variety of ways. The training module 620 may perform feature extraction multiple times, each time using a different feature-extraction technique. In an example, the feature sets generated using the different techniques may each be used to generate different machine learning-based classification models 640. As an example, the feature set with the highest quality metrics may be selected for use in training. The training module 620 may use the feature set(s) to build one or more machine learning-based classification models 640A-640N that are configured to indicate whether or not new data is associated with an indication that a search query-search result pair is associated with inappropriate content.

In an example, each of the training data sets 610A-610C may be analyzed to determine one or more groups of transcription error data, query data, and anomaly identifier data, respectively that have at least one feature that may be used to predict an indication associated with the first task, the second task, and the third task, respectively. As an example, each of the at least one features may comprise one or more characteristics of transcription error data, one or more characteristics of query data, and one or more characteristics of anomaly identifier data. Each of the one or more groups of transcription error data, query data, and anomaly identifier data may be considered as features (or variables) in the machine learning context. The term “feature,” as used herein, may refer to any characteristic of a group of transcription error data, a group of query data, and a group of anomaly identifier data that may be used to determine whether the group of transcription error data, the group of query data, and the group of anomaly identifier data fall within one or more specific categories (e.g., first task, second task, third task, etc.).

In an example, a feature selection technique may comprise one or more feature selection rules. The one or more feature selection rules may comprise a transcription error characteristic, query characteristic, and anomaly identifier characteristic occurrence rule. The transcription error characteristic, query characteristic, and anomaly identifier characteristic occurrence rule may comprise determining which transcription error characteristics, query characteristics, and anomaly identifier characteristics or groups of transcription error characteristics, query characteristics, and anomaly identifier characteristics in the training data sets 610A-610C occur over a threshold number of times and identifying those transcription error characteristics, query characteristics, and anomaly identifier characteristics that satisfy the threshold as candidate features. For example, any transcription error characteristics, query characteristics, and anomaly identifier characteristics or group of transcription error characteristics, query characteristics, and anomaly identifier characteristics that appear greater than or equal to 50 times in each of the training data sets 610A-610C may be considered as candidate features. Any transcription error characteristics, query characteristics, and anomaly identifier characteristics or group of transcription error characteristics, query characteristics, and anomaly identifier characteristics appearing less than 50 times may be excluded from consideration as a feature.

In an example, the one or more feature selection rules may comprise a significance rule. The significance rule may comprise determining, from the baseline feature level (e.g., baseline feature score) data in the training data sets 610A-610C, transcription error characteristic data, query characteristic data, and anomaly identifier characteristic data. As the baseline feature level (e.g., baseline feature score) in the training data set 610A are labeled according to one or more transcription errors, the labels may be used to determine the transcription error characteristic data. As the baseline feature level (e.g., baseline feature score) in the training data set 610B are labeled according to one or more queries, the labels may be used to determine the query characteristic data. As the baseline feature level (e.g., baseline feature score) in the training data set 610C are labeled according to one or more anomaly identifiers, the labels may be used to determine the anomaly identifier characteristic data.

In an example, a single feature selection rule may be applied to select features or multiple feature selection rules may be applied to select the features. For example, the feature selection rules may be applied in a cascading fashion, with the feature selection rules being applied in a specific order and applied to the results of the previous rule. For example, the transcription error characteristic occurrence rule, query characteristic occurrence rule, and anomaly identifier characteristic occurrence rule, respectively, may be applied to each of the training data sets 610A-610C to generate a first list of features. The significance rule may be applied to features in the first list of features to determine which features of the first list satisfy the significance rule in each of the training data sets 610A-610C and to generate a final list of candidate features.

The final list of candidate features may be analyzed according to additional feature selection techniques to determine one or more candidate feature signatures (e.g., groups of transcription error data that may be used to perform the first task, groups of query data that may be used to perform the second task, and groups of anomaly identifier data that may be used to perform the third task). Any suitable computational technique may be used to identify the candidate feature signatures using any feature selection technique such as filter, wrapper, and/or embedded methods. In an example, one or more candidate feature signatures may be selected according to a filter method. Filter methods include, for example, Pearson's correlation, linear discriminant analysis, analysis of variance (ANOVA), chi-square, combinations thereof, and the like. The selection of features according to filter methods are independent of any machine learning algorithms. Instead, features may be selected on the basis of scores in various statistical tests for their correlation with the outcome variable (e.g., one or more expected indications first task, second task, third task, respectively).

In an example, one or more candidate feature signatures may be selected according to a wrapper method. A wrapper method may be configured to use a subset of features and train a machine learning model using the subset of features. Based on the inferences that are drawn from a previous model, features may be added and/or deleted from the subset. Wrapper methods include, for example, forward feature selection, backward feature elimination, recursive feature elimination, combinations thereof, and the like. As an example, forward feature selection may be used to identify one or more candidate feature signatures. Forward feature selection is an iterative method that begins with no feature in the machine learning model. In each iteration, the feature which best improves the model is added until an addition of a new variable does not improve the performance of the machine learning model. As an example, backward elimination may be used to identify one or more candidate feature signatures. Backward elimination is an iterative method that begins with all features in the machine learning model. In each iteration, the least significant feature is removed until no improvement is observed on removal of features. As an example, recursive feature elimination may be used to identify one or more candidate feature signatures. Recursive feature elimination is a greedy optimization algorithm which aims to find the best performing feature subset. Recursive feature elimination repeatedly creates models and keeps aside the best or the worst performing feature at each iteration. Recursive feature elimination constructs the next model with the features remaining until all the features are exhausted. Recursive feature elimination then ranks the features based on the order of their elimination.

In an example, one or more candidate feature signatures may be selected according to an embedded method. Embedded methods combine the qualities of filter and wrapper methods. Embedded methods include, for example, Least Absolute Shrinkage and Selection Operator (LASSO) and ridge regression which implement penalization functions to reduce overfitting. For example, LASSO regression performs L1 regularization which adds a penalty equivalent to the absolute value of the magnitude of coefficients and ridge regression performs L2 regularization which adds a penalty equivalent to the square of the magnitude of coefficients.

After the training module 620 has generated a feature set(s) and trained each of the individual machine learning classifiers/models, the training module 620 may generate a machine learning-based classification model 640 based on the feature set(s). The machine learning-based classification model 640, may refer to a complex mathematical model for data classification that is generated using machine-learning techniques. In an example, this machine learning-based classifier may include a map of support vectors that represent boundary features. For example, boundary features may be selected from, and/or represent the highest-ranked features in, a feature set.

In an example, the training module 620 may use the feature sets extracted from each of the training data sets 610A-610C to build individual machine learning classification models that may be combined in order to train and build a machine learning-based classification model 640A-640N for each classification category (e.g., inappropriate content prediction). In an example, the machine learning-based classification models 640A-640N may be the individual machine learning classification models that are combined into a single machine learning-based classification model 640. Similarly, the machine learning-based classifier 630 may represent a single classifier containing a single or a plurality of machine learning-based classification models 640 and/or multiple classifiers containing a single or a plurality of machine learning-based classification models 640.

The extracted features (e.g., one or more candidate features and/or candidate feature signatures derived from the final list of candidate features) may be combined in a classification model trained using a machine learning approach such as: generative predictive machine learning (e.g., generative artificial intelligence, large language models, etc.); discriminant analysis; decision tree; a nearest neighbor (NN) algorithm (e.g., k-NN models, replicator NN models, etc.); statistical algorithm (e.g., Bayesian networks, etc.); clustering algorithm (e.g., k-means, mean-shift, etc.); neural networks (e.g., reservoir networks, artificial neural networks, etc.); support vector machines (SVMs); logistic regression algorithms; linear regression algorithms; Markov models or chains; principal component analysis (PCA) (e.g., for linear models); multi-layer perceptron (MLP) ANNs (e.g., for non-linear models); replicating reservoir networks (e.g., for non-linear models, typically for time series); random forest classification; a combination thereof and/or the like. The resulting machine learning-based classifier 630 may comprise a decision rule or a mapping that uses the expression levels of the features in the candidate feature signature to output an indication that a search query-search result pair is associated with inappropriate content.

The candidate feature signature and the machine learning-based classifier 630 may be used to output an indication that a search query-search result pair is associated with inappropriate content. In an example, the result for each test includes a confidence level that corresponds to a likelihood or a probability that the corresponding test predicted that a search query-search result pair is associated with inappropriate content. The confidence level may be a value between zero and one that represents a likelihood that the corresponding test is associated with an indication that a search query-search result pair is associated with inappropriate content. In an example, when there are two or more statuses (e.g., two or more expected indications that a search query-search result pair is associated with inappropriate content), the confidence level may correspond to a value p, which refers to a likelihood that a particular test is associated with a first status. In this case, the value 1−p may refer to a likelihood that the particular test is associated with a second status. In general, multiple confidence levels may be provided for each test and for each candidate feature signature when there are more than two statuses. A top performing candidate feature signature may be determined by comparing the result obtained for each test with known expected indications that a search query-search result pair is associated with inappropriate content for each test. In general, the top performing candidate feature signature will have results that closely match the known indications that a search query-search result pair is associated with inappropriate content.

The top performing candidate feature signature may be used to output an indication that a search query-search result pair is associated with inappropriate content. For example, transcription data, query data, and anomaly identifier data and/or baseline feature data may be determined/received. The transcription data, the query data, and the anomaly identifier data and/or the baseline feature data may be provided to the machine learning-based classifier 630 which may, based on the top performing candidate feature signature, predict/determine an indication that a search query-search result pair is associated with inappropriate content.

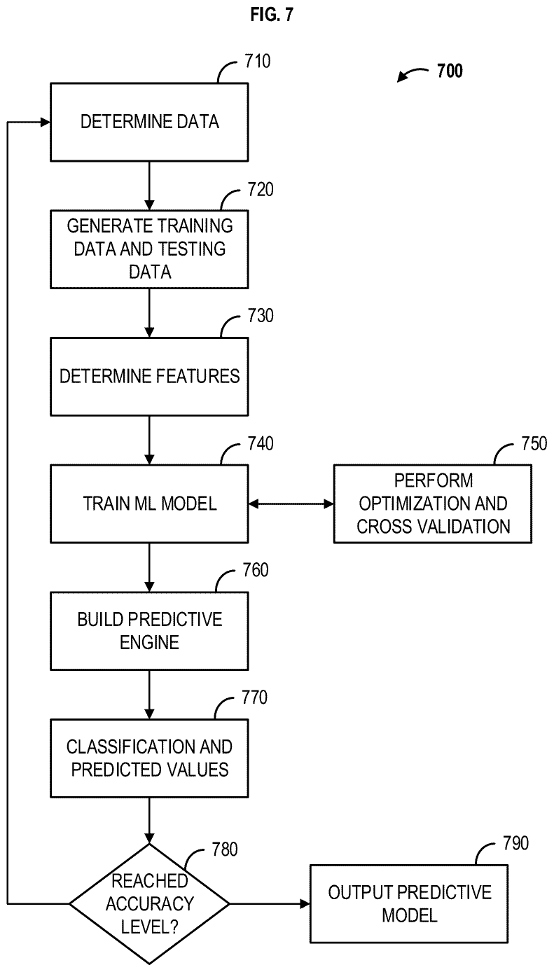

FIG. 7 shows a flowchart of an example training method 700 for generating the machine learning-based classifier 630 using the training module 620. The training module 620 may be implemented using supervised, semi-supervised (e.g., reinforcement based), self-supervised, unsupervised, student-teacher method, few-shot or zero shot classifier, and/or transfer learning machine learning-based classification models 640. The method 700 shown in FIG. 7 is an example of a supervised learning method. Although variations of this example training method are discussed below, other training methods may be analogously implemented to train unsupervised and/or semi-supervised machine learning models. As an example, supervised learning may involve leveraging labeled data from a large language model (LLM) validation module for the machine learning model to detect anomalies/changes from expected search behavior. As an example, semi-supervised learning may involve utilizing both labeled and unlabeled data to learn in order to improve model learning and generalization enabling the machine learning model to leverage structured labeled data while also learning from the patterns of unlabeled data. As an example, self-supervised learning may involve pre-training on large-scale unlabeled search data before task-specific fine-tuning (e.g., to pre-train a large language model such as BERT, or LLAMA, or GPT-2 or lower only). As an example, unsupervised machine learning may involve pre-training and/or applying clustering or other anomaly detection techniques to identify search result anomalies. As an example, student-teacher method learning may involve tuning a task specific model or a language model, wherein a large, complex model transfers knowledge to a smaller, efficient model for faster inference via techniques such as knowledge distillation, teacher-student learning, model pruning, quantization, Low-rank adaptation (LoRA) or quantized LoRA (QLoRA), etc. As an example, few-shot or zero-shot classifier learning may involve a language model being used to detect anomalies in search results with minimal examples. As an example, transfer learning may involve fine-tuning/retraining weights of a model already pre-trained on a broader dataset, to adapt to the domain of TV/search content anomalies.

The training method 700 may determine (e.g., access, receive, retrieve, etc.) training data (e.g., transcription error data, query data, and anomaly identifier data) for training one or more machine learning models at 710. The training data may contain one or more datasets, wherein one or more datasets may be determined based on one or more groupings of each of the transcription error data, query data, and anomaly identifier data. As an example, each dataset may include a labeled list of filter features. For example, each dataset may comprise labeled feature data.

The training method 700 may generate, at 720, one or more training data sets and one or more testing data sets. The one or more training data sets and the one or more testing data sets may be generated by randomly assigning labeled feature data of individual features from the transcription error data, the query data, and the anomaly identifier data to either the one or more training data sets or the one or more testing data sets. In an example, the assignment of the labeled feature data of individual features may not be completely random. In an example, only the labeled feature data for specific groupings of each of the transcription error data, the query data, and the anomaly identifier data may be used to generate the one or more training data sets and the one or more testing data sets. In an example, a majority of the labeled feature data for each of the specific groupings of each of the transcription error data, the query data, and the anomaly identifier data may be used to generate the one or more training data sets. For example, 75% of the labeled feature data for each of the specific groupings of each of the transcription error data, the query data, and the anomaly identifier data may be used to generate the one or more training data sets and 25% may be used to generate the one or more testing data sets. In an example, only the labeled feature data for each of the specific groupings of each of the transcription error data, the query data, and the anomaly identifier data may be used to generate the one or more training data sets and the one or more testing data sets.

The training method 700 may determine (e.g., extract, select, etc.), at 730, one or more features that can be used by, for example, a classifier to differentiate among different classifications (e.g., first task, second task, and third task). The one or more features may comprise one or more groups of transcription error datasets, query datasets, and anomaly identifier datasets. In an example, the training method 700 may determine a set of features from the transcription error data, the query data, and the anomaly identifier data. In an example, a set of features may be determined from the transcription error data, the query data, and the anomaly identifier data from a different grouping than the grouping associated with the labeled feature data of the one or more training data sets and the one or more testing data sets. In other words, the transcription error data, the query data, and the anomaly identifier data from the different grouping may be used for feature determination, rather than for training one or more machine learning models. In an example, the one or more training data sets may be used in conjunction with the transcription error data, the query data, and the anomaly identifier data from the different grouping to determine the one or more features. The transcription error data, the query data, and the anomaly identifier data from the different grouping may be used to determine an initial set of features, which may be further reduced using the one or more training data sets.

The training method 700 may train one or more machine learning models using the one or more features at 740. As an example, the one or more machine learning models may be trained using supervised learning. As an example, other machine learning techniques may be employed, including unsupervised learning and semi-supervised. The machine learning models trained at 740 may be selected based on different criteria depending on the problem to be solved and/or data available in the one or more training data sets. For example, machine learning classifiers can suffer from different degrees of bias. Accordingly, more than one machine learning model may be trained at 740, optimized, improved, and cross-validated at 750.

The training method 700 may select one or more machine learning models to build a predictive model at 760 (e.g., a machine learning classifier). The predictive model may be evaluated using the one or more testing data sets. The predictive model may analyze the one or more testing data sets and generate classification values and/or predicted values at 770. Classification and/or prediction values may be evaluated at 780 to determine whether such values have achieved a desired accuracy level. Performance of the predictive model may be evaluated in a number of ways based on a number of true positive, false positive, true negative, and/or false negative classifications of the plurality of data points indicated by the predictive model. For example, the false positives of the predictive model may refer to a number of times the predictive model incorrectly predicted a search query-search result pair was associated with inappropriate content based on the transcription error data, the query data, and the anomaly identifier data. Conversely, the false negatives of the predictive model may refer to a number of times the machine learning model determined that a search query-search result pair was not associated with inappropriate content when, in fact, the a search query-search result pair was associated with inappropriate content. True negatives and true positives may refer to a number of times the predictive model correctly classified whether a search query-search result pair was associated with inappropriate content based on the transcription error data, the query data, and the anomaly identifier data. Related to these measurements are the concepts of recall and precision. Generally, recall refers to a ratio of true positives to a sum of true positives and false negatives, which quantifies a sensitivity of the predictive model. Similarly, precision refers to a ratio of true positives to a sum of true and false positives.

When a desired accuracy level is reached, the training phase ends and the predictive model may be output at 790; when the desired accuracy level is not reached, however, then a subsequent iteration of the training method 700 may be performed starting at 710 with variations such as, for example, considering a larger collection of transcription error data, query data, and anomaly identifier data.

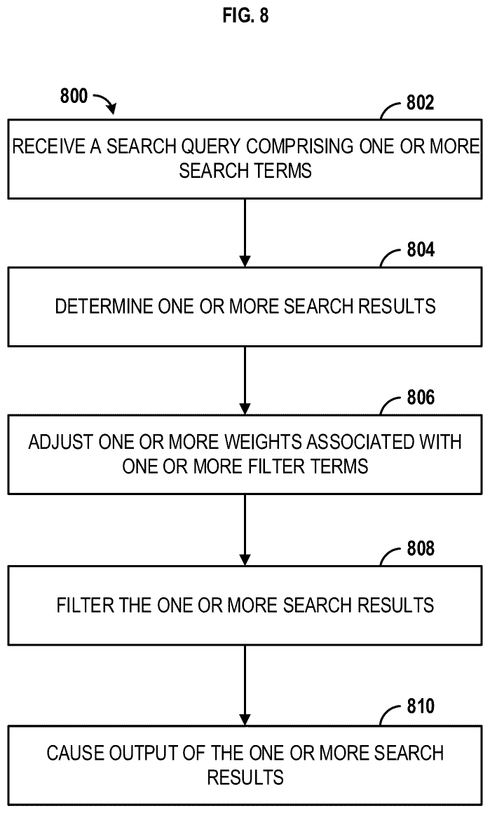

FIG. 8 shows an example method 800 for detecting anomalies associated with search results and filtering content based on the detected anomalies. Method 800 may be implemented by a computing device (e.g., the device 102, the computing device 104, or the network device 116, or any combination thereof). At step 802, a search query comprising one or more search terms may be received. For example, a computing device (e.g., the device 102, the computing device 104, or the network device 116) may receive the search query comprising the one or more search terms. The search query may comprise one or more of voice input, image input, or text input. For example, the voice input may be preprocessed (e.g., via one or more voice-to-text algorithms) to identify the one or more search terms provided via the voice input. For example, the image input may be preprocessed (e.g., via one or more content recognition algorithms) to identify the one or more search terms provided via the image input. For example, the text input may be preprocessed (e.g., via one or more optical character recognition algorithms) to identify the one or more search terms provided via the text input.

At step 804, one or more search results may be determined based on the one or more search terms. For example, the computing device (e.g., the device 102, the computing device 104, or the network device 116) may determine the one or more search results based on the one or more search terms. As an example, the one or more search results may comprise content associated with one or more filter terms that are related to the one or more search terms. The content associated with the one or more filter terms may comprise one or more of video content, audio content, or text content. As an example, one or more video content items may be output to a user that are associated with the one or more filter terms. As an example, one or more audio content items may be output to a user that are associated with the one or more filter terms. As an example, one or more text descriptions associated with one or more content items may be output to a user that are associated with the one or more filter terms.

At step 806, one or more weights associated with one or more filter terms may be adjusted based on the one or more search terms. For example, the computing device (e.g., the device 102, the computing device 104, or the network device 116) may adjust the one or more weights associated with the one or more filter terms based on the one or more search terms. As an example, each weight of the one or more weights may be assigned to each filter term of the one or more filter terms. The one or more weights assigned to the one or more filter terms may indicate that the one or more filter terms comprise one or more anomalous terms associated with inappropriate content. For example, each weight may be assigned to each filter term based on each filter term's relatedness to inappropriate content (e.g., adult content/language, offensive content/language, etc.). For example, a higher weight/value may be assigned to a filter term (e.g., a negative term) the more likely it is related to inappropriate content. For example, a weight/value that satisfies a threshold (e.g., is above the threshold) may indicate that a filter term is associated with inappropriate content. For example, the higher weight that satisfies the threshold (e.g., is above the threshold) may indicate that the filter term comprises an anomalous term, and thus, is associated with inappropriate content. As an example, the weights may be assigned to the filter terms based on one or more criteria such as text-analysis, phrase-level embeddings, word-level embeddings, character level embeddings, sub-word tokenization, sentence embeddings, named entity recognition (NER), parts of speech tagging (POS Tagging), semantic similarity scoring, contextual embeddings, and transformer-based sequence modeling, etc. As an example, the one or more weights may be adjusted based on the one or more filter terms matching at least one search term of the one or more search terms. For example, the one or more weights may be adjusted such that the one or more filter terms become less negative if the one or more filter terms are used in the search query.

At step 808, the one or more search results may be filtered based on the one or more filter terms. For example, the computing device (e.g., the device 102, the computing device 104, or the network device 116) may filter the one or more search results based on the one or more filter terms. For example, the one or more search results may be filtered to remove the content associated with the one or more filter terms. For example, the one or more search results may be filtered (e.g., ranked) based on each weight associated with each filter term. As an example, the one or more search results associated with the one or more filter terms with weights that satisfy the threshold (e.g., above the threshold) may be removed from the one or more search results. For example, if the filter term is associated with a weight that satisfies the threshold (e.g., above the threshold), and thus, comprises an anomalous term that is associated with inappropriate content, the inappropriate content associated with the filter term may be removed from the one or more search results prior to outputting the one or more search results to a user. In an example, the one or more search results may be filtered based on each adjusted weight of each filter term. As an example, if the adjusted weight associated with the filter term satisfies the threshold (e.g., remains above the threshold), the content associated with the filter term may be removed from the one or more search results prior to outputting the one or more search results to a user. If the adjusted weight associated with the filter term does not satisfy the threshold (e.g., is below the threshold), the content associated with the filter term may be kept in the one or more search results.

In an example, a weight/value (e.g., an impact relevancy score) may be assigned to the search query (e.g., based on the weights, or adjusted weights, of the one or more filter terms associated with the search query). The adjusted weight, associated with the filter term, may be compared with the search query weight (e.g., impact relevancy score) to determine whether to remove the content associated with the filter term from the one or more search results. For example, if a search query's weight does not satisfy the threshold (e.g., falls below the threshold) while the filter term satisfies the threshold (e.g., exceeds the threshold), the content associated with the filter term may be removed from the one or more search results. Thus, the weights of the filter terms may be adjusted in order to accommodate for the context of the search terms of the search query in order to indicate anomalies associated with contextually inappropriate content. For example, these anomalies may be defined as search results that contain any inappropriate content relevant to the search query, when the search query did not specifically include terms directed to the inappropriate content. However, the search terms may not be considered anomalies if the search query includes terms directed towards such content. This enables the computing device to analyze the search query to identify search results that are more relevant to the search query without over-filtering the search results, blocking categories of content and potentially limiting user access to desired material. Thus, the computing device may appropriately filter the search results, without under-filtering the search results, in order to remove contextually inappropriate content from the search results.

At step 810, the one or more search results may be output. For example, the computing device (e.g., the device 102, the computing device 104, or the network device 116) may cause the one or more search results to be output (e.g., displayed).

The method 800 described in FIG. 8 represents a technical improvement to the problem of accurately filtering search results while maintaining relevance and context (for example, in real-time). By implementing a weighting system for filter terms and adjusting those weights based on matches with search terms, the method 800 may enhance the precision of content filtering. This approach allows for more nuanced analysis of search queries and results, reducing both false positives and false negatives in identifying inappropriate content. The iterative process of adjusting weights and filtering results based on the adjusted weights enables the system to adapt to the context of each specific search query, striking a balance between removing truly inappropriate content and preserving access to relevant information. This contextual understanding overcomes limitations of static keyword-based filtering systems, improving the overall user experience while maintaining content safety standards. Additionally, by considering both the weights of filter terms and search terms, the method 800 provides a more comprehensive evaluation of content appropriateness, leading to more accurate and efficient filtering of search results.

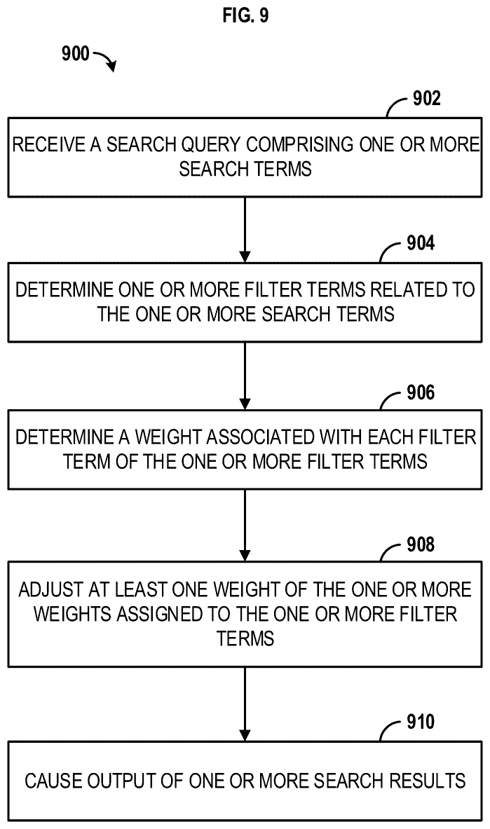

FIG. 9 shows an example method 900 for detecting anomalies associated with search results and filtering content based on the detected anomalies. Method 900 may be implemented by a computing device (e.g., the device 102, the computing device 104, or the network device 116, or any combination thereof). At step 902, a search query comprising one or more search terms may be received. For example, a computing device (e.g., the device 102, the computing device 104, or the network device 116) may receive the search query comprising the one or more search terms. The search query may comprise one or more of voice input, image input, or text input. For example, the voice input may be preprocessed (e.g., via one or more voice-to-text algorithms) to identify the one or more search terms provided via the voice input. For example, the image input may be preprocessed (e.g., via one or more content recognition algorithms) to identify the one or more search terms provided via the image input. For example, the text input may be preprocessed (e.g., via one or more optical character recognition algorithms) to identify the one or more search terms provided via the text input.

At step 904, one or more filter terms related to the one or more search terms may be determined. For example, the computing device (e.g., the device 102, the computing device 104, or the network device 116) may determine the one or more filter terms related to the one or more search terms.

At step 906, a weight associated with each filter term of the one or more filter terms may be determined. For example, the computing device (e.g., the device 102, the computing device 104, or the network device 116) may determine the weight associated with each filter term of the one or more filter terms. For example, each weight may be assigned to each filter terms. As an example, the one or more weights assigned to the one or more filter terms may indicate that the one or more filter terms comprise one or more anomalous terms associated with inappropriate content. For example, each weight may be assigned to each filter term based on each filter term's relatedness to inappropriate content (e.g., adult content/language, offensive content/language, etc.). For example, a higher weight/value may be assigned to a filter term (e.g., a negative term) the more likely it is related to inappropriate content. For example, a weight/value that satisfies a threshold (e.g., that is above the threshold) may indicate that a filter term is associated with inappropriate content. For example, the higher weight that satisfies the threshold (e.g., that is above the threshold) may indicate that the filter term comprises an anomalous term, and thus, is associated with inappropriate content. As an example, the weights may be assigned to the filter terms based on one or more criteria such as text-analysis, phrase-level embeddings, word-level embeddings, character level embeddings, sub-word tokenization, sentence embeddings, named entity recognition (NER), parts of speech tagging (POS Tagging), semantic similarity scoring, contextual embeddings, and transformer-based sequence modeling, etc.

At step 908, at least one weight of the one or more weights assigned to the one or more filter terms may be adjusted based on the one or more search terms and the one or more filter terms. For example, the computing device (e.g., the device 102, the computing device 104, or the network device 116) may adjust the at least one weight of the one or more weights assigned to the one or more filter terms based on the one or more search terms and the one or more filter terms. As an example, the at least one weight may be adjusted based on at least one filter term of the one or more filter terms matching at least one search term of the one or more search terms. For example, the at least one weight may be adjusted such that the at least one filter term becomes less negative if the at least one filter term is used in the search query.

At step 910, one or more search results may be output based on the adjusted at least one weight. For example, the computing device (e.g., the device 102, the computing device 104, or the network device 116) may cause output of the one or more search results based on the adjusted at least one weight. For example, the one or more search results may be filtered based on the adjusted at least one weight. For example, the one or more search results may be filtered to remove content associated with the at least one filter term that is associated with, or assigned, the adjusted at least one weight. The one or more search results associated with the at least one filter term with the at least one weight that satisfies the threshold (e.g., above the threshold) may be removed from the one or more search results. For example, if the at least one filter term is associated with a weight that satisfies the threshold (e.g., is above the threshold), and thus, comprises an anomalous term that is associated with inappropriate content, the inappropriate content associated with the least one filter term may be removed from the one or more search results prior to outputting the one or more search results to a user. The content associated with the one or more search results may comprise one or more of video content, audio content, or text content. As an example, one or more video content items may be output to a user that are associated with the one or more search results. As an example, one or more audio content items may be output to a user that are associated with the one or more search results. As an example, one or more text descriptions associated with one or more content items may be output to a user that are associated with the one or more search results. In an example, causing the output of one or more search results may comprise causing the output of content associated with the one or more search results.

In an example, a weight/value (e.g., an impact relevancy score) may be assigned to the search query (e.g., based on the weights, or adjusted weights, of the one or more filter terms associated with the search query). The adjusted weight, associated with the filter term, may be compared with the search query weight (e.g., impact relevancy score) to determine whether to remove the content associated with the filter term from the one or more search results. For example, if a search query's weight does not satisfy the threshold (e.g., falls below the threshold) while the filter term satisfies the threshold (e.g., exceeds the threshold), the content associated with the filter term may be removed from the one or more search results. Thus, the weights of the filter terms may be adjusted in order to accommodate for the context of the search terms of the search query in order to indicate anomalies associated with contextually inappropriate content. For example, these anomalies may be defined as search results that contain any inappropriate content relevant to the search query, when the search query did not specifically include terms directed to the inappropriate content. However, the search terms may not be considered anomalies if the search query includes terms directed towards such content. This enables the computing device to analyze the search query to identify search results that are more relevant to the search query without over-filtering the search results, blocking categories of content and potentially limiting user access to desired material. Thus, the computing device may appropriately filter the search results, without under-filtering the search results, in order to remove contextually inappropriate content from the search results.

The method 900 described in FIG. 9 represents a technical improvement to the problem of accurately filtering search results while maintaining relevance and context (for example, in real-time). By implementing a weighting system for filter terms and adjusting those weights based on matches with search terms, the method 900 may enhance the precision of content filtering. This approach allows for more nuanced analysis of search queries and results, reducing both false positives and false negatives in identifying inappropriate content. The iterative process of adjusting weights and filtering results based on the adjusted weights enables the system to adapt to the context of each specific search query, striking a balance between removing truly inappropriate content and preserving access to relevant information. This contextual understanding overcomes limitations of static keyword-based filtering systems, improving the overall user experience while maintaining content safety standards. Additionally, by considering both the weights of filter terms and search terms, the method 800 provides a more comprehensive evaluation of content appropriateness, leading to more accurate and efficient filtering of search results.

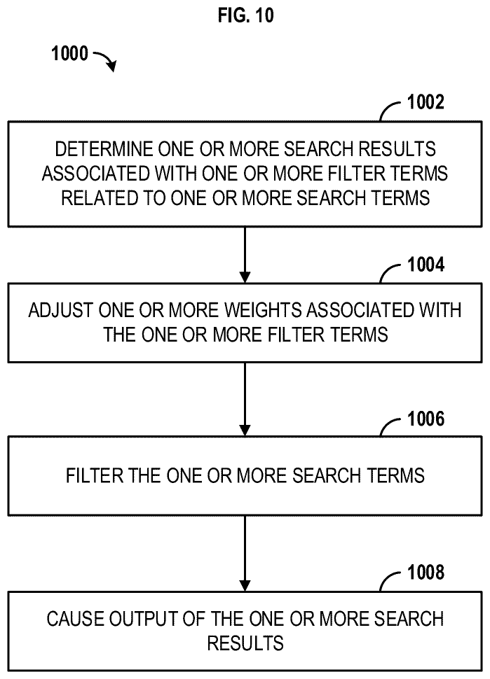

FIG. 10 shows an example method 1000 for detecting anomalies associated with search results and filtering content based on the detected anomalies. Method 1000 may be implemented by a computing device (e.g., the device 102, the computing device 104, or the network device 116, or any combination thereof). At step 1002, one or more search results associated with one or more filter terms that are related to one or more search terms may be determined. For example, a computing device (e.g., the device 102, the computing device 104, or the network device 116) may determine the one or more search results associated with the one or more filter terms that are related to the one or more search terms. As an example, a search query comprising the one or more search terms may be received. The search query may comprise one or more of voice input, image input, or text input. For example, the voice input may be preprocessed (e.g., via one or more voice-to-text algorithms) to identify one or more search terms provided via the voice input. For example, the image input may be preprocessed (e.g., via one or more content recognition algorithms) to identify one or more search terms provided via the image input. For example, the text input may be preprocessed (e.g., via one or more optical character recognition algorithms) to identify one or more search terms provided via the text input.

At step 1004, one or more weights associated with the one or more filter terms may be adjusted based on the one or more search terms and the one or more filter terms. For example, the computing device (e.g., the device 102, the computing device 104, or the network device 116) may adjust the one or more weights associated with the one or more filter terms based on the one or more search terms and the one or more filter terms. As example, each weight of the one or more weights may be assigned to each filter term of the one or more filter terms. The one or more weights assigned to the one or more filter terms may indicate that the one or more filter terms comprise one or more anomalous terms associated with inappropriate content. For example, each weight may be assigned to each filter term based on each filter term's relatedness to inappropriate content (e.g., adult content/language, offensive content/language, etc.). For example, a higher weight/value may be assigned to a filter term (e.g., a negative term) the more likely it is related to inappropriate content. For example, a weight/value that satisfies a threshold (e.g., is above the threshold) may indicate that a filter term is associated with inappropriate content. For example, the higher weight that satisfies the threshold (e.g., is above the threshold) may indicate that the filter term comprises an anomalous term, and thus, is associated with inappropriate content. As an example, the weights may be assigned to the filter terms based on one or more criteria such as text-analysis, phrase-level embeddings, word-level embeddings, character level embeddings, sub-word tokenization, sentence embeddings, named entity recognition (NER), parts of speech tagging (POS Tagging), semantic similarity scoring, contextual embeddings, and transformer-based sequence modeling, etc. As an example, the one or more weights may be adjusted based on at least one filter term of the one or more filter terms matching at least one search term of the one or more search terms. For example, the one or more weights may be adjusted such that one or more of the filter terms become less negative if one or more of the filter terms are used in the search query.

At step 1006, the one or more search results may be filtered based on the adjusted one or more weights. For example, the computing device (e.g., the device 102, the computing device 104, or the network device 116) may filter the one or more search results based on the adjusted one or more weights. For example, the one or more search results may be filtered to remove content associated with the one or more filter terms. The content associated with the one or more filter terms may comprise one or more of video content, audio content, or text content. As an example, one or more video content items may be output to a user that are associated with the one or more filter terms. As an example, one or more audio content items may be output to a user that are associated with the one or more filter terms. As an example, one or more text descriptions associated with one or more content items may be output to a user that are associated with the one or more filter terms. The one or more search results may be filtered (e.g., ranked) based on each weight assigned to each filter term. For example, content associated with filter terms associated with higher weights, indicating a higher likelihood the filter term comprises an anomalous term associated with inappropriate content, may be ranked lower amongst the search results. As result, content associated with an anomalous term is less likely to be included in the search results output (e.g., displayed) to a user. As an example, search results associated with filter terms with weights that satisfy the threshold (e.g., above the threshold) may be removed from the one or more search results. For example, if the filter term is associated with a weight that satisfies the threshold (e.g., above the threshold), and thus, comprises an anomalous term that is associated with inappropriate content, the inappropriate content associated with the filter term may be removed from the one or more search results prior to outputting the one or more search results to a user.

In an example, a weight/value (e.g., an impact relevancy score) may be assigned to the search query (e.g., based on the weights, or adjusted weights, of the one or more filter terms associated with the search query). The adjusted weight, associated with the filter term, may be compared with the search query weight (e.g., impact relevancy score) to determine whether to remove the content associated with the filter term from the one or more search results. For example, if a search query's weight does not satisfy the threshold (e.g., falls below the threshold) while the filter term satisfies the threshold (e.g., exceeds the threshold), the content associated with the filter term may be removed from the one or more search results. Thus, the weights of the filter terms may be adjusted in order to accommodate for the context of the search terms of the search query in order to indicate anomalies associated with contextually inappropriate content. For example, these anomalies may be defined as search results that contain any inappropriate content relevant to the search query, when the search query did not specifically include terms directed to the inappropriate content. However, the search terms may not be considered anomalies if the search query includes terms directed towards such content. This enables the computing device to analyze the search query to identify search results that are more relevant to the search query without over-filtering the search results, blocking categories of content and potentially limiting user access to desired material. Thus, the computing device may appropriately filter the search results, without under-filtering the search results, in order to remove contextually inappropriate content from the search results.

At step 1008, the one or more search results may be output. For example, the computing device (e.g., the device 102, the computing device 104, or the network device 116) may cause the one or more search results to be output (e.g., displayed).

The method 1000 described in FIG. 10 represents a technical improvement to the problem of accurately filtering search results while preserving relevant content. By implementing a weighting system that considers both filter terms and search terms, the method 1000 enhances the precision and context-awareness of content filtering. This approach allows for more nuanced analysis of search queries and results, reducing false positives in identifying inappropriate content while retaining valuable information. The iterative process of adjusting weights based on term matches and filtering results based on the adjusted weights enables the system to adapt to the specific context of each search query, striking a balance between removing truly inappropriate content and preserving access to relevant information. Additionally, by considering the weights of both filter terms and search terms in the filtering decision, the method 1000 provides a more comprehensive evaluation of content appropriateness. This multi-faceted approach leads to more accurate and efficient filtering of search results, improving the overall user experience by delivering more relevant content while maintaining appropriate content standards.

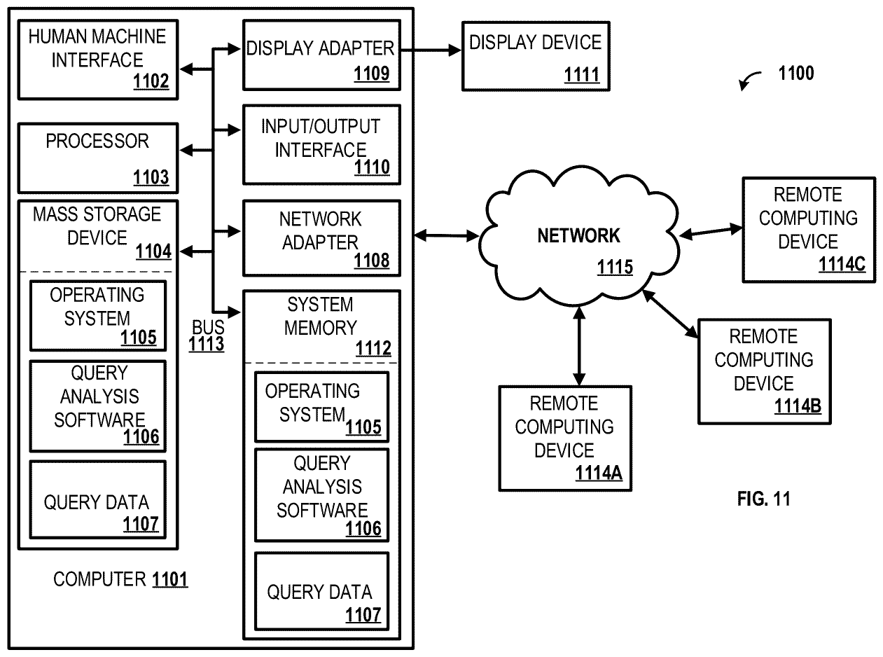

The methods and systems can be implemented on a computer 1101 as illustrated in FIG. 11 and described below. By way of example, computing device 104, device 102, and/or the network device 116 of FIG. 1 can be a computer 1101 as illustrated in FIG. 11. Similarly, the methods and systems disclosed can utilize one or more computers to perform one or more functions in one or more locations. FIG. 11 is a block diagram illustrating an example operating environment 1100 for performing the disclosed methods. This example operating environment 1100 is only an example of an operating environment and is not intended to suggest any limitation as to the scope of use or functionality of operating environment architecture. Neither should the operating environment 1100 be interpreted as having any dependency or requirement relating to any one or combination of components illustrated in the example operating environment 1100.

The present methods and systems can be operational with numerous other general purpose or special purpose computing system environments or configurations. Examples of well-known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, and/or the like that perform particular tasks or implement particular abstract data types. The disclosed methods can also be practiced in grid-based and distributed computing environments where tasks are performed by remote processing devices that are linked through a communications network. In a distributed computing environment, program modules can be located in local and/or remote computer storage media such as memory storage devices.

Further, one skilled in the art will appreciate that the systems and methods disclosed herein can be implemented via a general-purpose computing device in the form of a computer 1101. The computer 1101 can comprise one or more components, such as one or more processors 1103, a system memory 1112, and a bus 1113 that couples various components of the computer 1101 comprising the one or more processors 1103 to the system memory 1112. The system can utilize parallel computing.

The bus 1113 can comprise one or more of several possible types of bus structures, such as a memory bus, memory controller, a peripheral bus, an accelerated graphics port, or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 1113, and all buses specified in this description can also be implemented over a wired or wireless network connection and one or more of the components of the computer 1101, such as the one or more processors 1103, a mass storage device 1104, an operating system 1105, query analysis software 1106, query data 1107, a network adapter 1108, the system memory 1112, an Input/Output Interface 1110, a display adapter 1109, a display device 1111, and a human machine interface 1102, can be contained within one or more remote computing devices 1114A-1114C at physically separate locations, connected through buses of this form, in effect implementing a fully distributed system.

The computer 1101 typically comprises a variety of computer readable media. Examples of readable media can be any available media that is accessible by the computer 1101 and comprises, for example and not meant to be limiting, both volatile and non-volatile media, removable and non-removable media. The system memory 1112 can comprise computer readable media in the form of volatile memory, such as random access memory (RAM), and/or non-volatile memory, such as read only memory (ROM). The system memory 1112 typically can comprise data such as the query data 1107 and/or program modules such as the operating system 1105 and the query analysis software 1106 that are accessible to and/or are operated on by the one or more processors 1103.

In another aspect, the computer 1101 can also comprise other removable/non-removable, volatile/non-volatile computer storage media. The mass storage device 1104 can provide non-volatile storage of computer code, computer readable instructions, data structures, program modules, and other data for the computer 1101. For example, the mass storage device 1104 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 1104, such as, by way of example, the operating system 1105 and the query analysis software 1106. One or more of the operating system 1105 and the query analysis software 1106 (or some combination thereof) can comprise elements of the programming and the query analysis software 1106. The query data 1107 can also be stored on the mass storage device 1104. The product recognition data 1407 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple locations within the network 1115.

In another aspect, the user can enter commands and information into the computer 1401 via an input device (not shown). Examples of such input devices comprise, but are not limited to, a keyboard, pointing device (e.g., a computer mouse, remote control), a microphone, a joystick, a scanner, tactile input devices such as gloves, and other body coverings, motion sensor, and the like These and other input devices can be connected to the one or more processors 1103 via the human machine interface 1102 that is coupled to the bus 1113, but can be connected by other interface and bus structures, such as a parallel port, game port, an IEEE 1394 Port (also known as a Firewire port), a serial port, a network adapter 1108, and/or a universal serial bus (USB).

In yet another aspect, the display device 1111 can also be connected to the bus 1113 via an interface, such as the display adapter 1109. It is contemplated that the computer 1101 can have more than one display adapter 1109 and the computer 1101 can have more than one display device 1111. For example, the display device 1111 can be a monitor, an LCD (Liquid Crystal Display), light emitting diode (LED) display, television, smart lens, smart glass, and/or a projector. In addition to the display device 1111, other output peripheral devices can comprise components such as speakers (not shown) and a printer (not shown) which can be connected to the computer 1101 via an Input/Output Interface 1110. Any step and/or result of the methods can be output in any form to an output device. Such output can be any form of visual representation, comprising, but not limited to, textual, graphical, animation, audio, tactile, and the like. The display device 1111 and the computer 1101 can be part of one device, or separate devices.

The computer 1101 can operate in a networked environment using logical connections to one or more remote computing devices 1114A-1114C. By way of example, a remote computing device 1114A-1114C can be a personal computer, computing station (e.g., workstation), portable computer (e.g., laptop, mobile phone, tablet device), smart device (e.g., smartphone, smart watch, activity tracker, smart apparel, smart accessory), security and/or monitoring device, a server, a router, a network computer, a peer device, edge device or other common network node, and so on. Logical connections between the computer 1101 and a remote computing device 1114A-1114C can be made via a network 1115, such as a local area network (LAN) and/or a general wide area network (WAN). Such network connections can be through the network adapter 1108. The network adapter 1108 can be implemented in both wired and wireless environments. Such networking environments are conventional and commonplace in dwellings, offices, enterprise-wide computer networks, intranets, and the Internet.

For purposes of illustration, application programs and other executable program components such as the operating system 1105 are illustrated herein as discrete blocks, although it is recognized that such programs and components can reside at various times in different storage components of the computing device 1101, and are executed by the one or more processors 1103 of the computer 1101. An implementation of the query analysis software 1106 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” can comprise volatile and non-volatile, removable and non-removable media implemented in any methods or technology for storage of information such as computer readable instructions, data structures, program modules, or other data. Example computer storage media can comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ artificial intelligence (AI) techniques such as machine learning and iterative learning. Examples of such techniques comprise, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, such as: matters of logic with respect to arrangement of steps or operational flow; plain meaning derived from grammatical organization or punctuation; the number or type of embodiments described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as examples only, with a true scope and spirit being indicated by the following claims.

1. A method comprising:
receiving, by a computing device, a search query comprising one or more search terms;
determining, based on the one or more search terms, one or more search results;
adjusting, based on the one or more search terms, one or more weights associated with one or more filter terms;
prior to outputting content associated with the one or more search results, filtering, based on the one or more filter terms, the one or more search results by removing content associated with at least one filter term of the one or more filter terms from the one or more search results; and
causing output of content associated with the filtered one or more search results.

2. The method of claim 1, wherein the search query comprises one or more of voice input, image input, or text input associated with the one or more search terms.

3. The method of claim 1, further comprising assigning each weight of the one or more weights to each filter term of the one or more filter terms.

4. The method of claim 1, wherein the one or more weights associated with the one or more filter terms indicates that the one or more filter terms comprise one or more anomalous terms associated with inappropriate content.

5. The method of claim 1, wherein adjusting, based on the one or more search terms, the one or more weights associated with the one or more filter terms comprises:
determining the one or more filter terms match at least one search term of the one or more search terms; and
adjusting, based on the one or more filter terms matching the at least one search term, the one or more weights associated with the one or more filter terms.

6. The method of claim 1, further comprising: assigning the one or more weights to the one or more filter terms.

7. The method of claim 1, wherein the content associated with the one or more filter terms comprises one or more of video content, audio content, or text content.

8. The method of claim 1, wherein the one or more weights are assigned to the one or more filter terms based on one or more natural language processing operations performed on the one or more filter terms.

9. A method comprising:
receiving, by a computing device, a search query comprising one or more search terms;
determining one or more filter terms related to the one or more search terms;
determining a weight associated with each filter term of the one or more filter terms;
adjusting, based on the one or more search terms and the one or more filter terms, at least one weight of the one or more weights associated with the one or more filter terms; and
causing, based on the adjusted at least one weight, output of content associated with one or more search results, wherein content associated with at least one filter term of the one or more filter terms is removed from the one or more search results based on the adjusted at least one weight prior to the output of the content associated with the one or more search results.

10. The method of claim 9, wherein the search query comprises one or more of voice input, image input, or text input associated with the one or more search terms.

11. The method of claim 9, wherein the one or more weights associated with the one or more filter terms indicates that the one or more filter terms comprise one or more anomalous terms associated with inappropriate content.

12. The method of claim 9, wherein adjusting, based on the one or more search terms and the one or more filter terms, the at least one weight of the one or more weights comprises adjusting, based on at least one search term of the one or more search terms matching at least one filter term of the one or more filter terms, the at least one weight of the one or more weights.

13. The method of claim 9, wherein the one or more weights are assigned to the one or more filter terms based on one or more natural language processing operations performed on the one or more filter terms.

14. The method of claim 13, wherein the content associated with the one or more search results comprises one or more of video content, audio content, or text content.

15. A method comprising:
determining, by a computing device, one or more search results associated with one or more filter terms related to one or more search terms;
adjusting, based on the one or more search terms and the one or more filter terms, one or more weights associated with the one or more filter terms;
prior to outputting content associated with the one or more search results, filtering, based on the adjusted one or more weights, the one or more search results by removing content associated with at least one filter term of the one or more filter terms from the one or more search results; and
causing output of content associated with the filtered one or more search results.

16. The method of claim 15, further comprising receiving a search query comprising the one or more search terms, wherein the search query comprises one or more of voice input, image input, or text input associated with the one or more search terms.

17. The method of claim 15, wherein the one or more weights associated with the one or more filter terms indicates that the one or more filter terms comprise one or more anomalous terms associated with inappropriate content.

18. The method of claim 15, wherein adjusting, based on the one or more search terms and the one or more filter terms, the one or more weights associated with the one or more filter terms comprises adjusting, based on at least one search term of the one or more search terms matching at least one filter term of the one or more filter terms, the one or more weights associated with the one or more filter terms.

19. The method of claim 15, wherein the one or more weights are assigned to the one or more filter terms based on one or more natural language processing operations performed on the one or more filter terms.

20. The method of claim 19, wherein the content associated with the one or more search results comprises one or more of video content, audio content, or text content.
